(19) United States
(12) Patent Application Publication
(10) Pub. No.: US 2015/0370569 A1
(43) Pub. Date: Dec. 24, 2015

(54) INSTRUCTION PROCESSING SYSTEM AND METHOD

(71) Applicant: SHANGHAI XINHAO MICROELECTRONICS CO. LTD., Shanghai (CN)

(72) Inventor: KENNETH CHENGHAO LIN, Shanghai (CN)

(21) Appl. No.: 14/766,452

(22) PCT Filed: Jan. 29, 2014
(86) PCT No.: PCT/CN2014/071794

§ 371 Date: Aug. 6, 2015

(30) Foreign Application Priority Data
Feb. 7, 2013 (CN) 201310049989.0
Dec. 31, 2013 (CN) 201310755250.1
Jan. 14, 2014 (CN) 201410022576.8

(51) Int. Cl. G06F 9/32

(52) U.S. Cl. CPC G06F 9/32

(57) ABSTRACT

An instruction processing system is provided. The system includes a central processing unit (CPU), an m number of memory devices and an instruction control unit. The CPU is capable of being coupled to the m number of memory devices. Further, the CPU is configured to execute one or more instructions of the executable instructions. The m number of memory devices with different access speeds are configured to store the instructions, where m is a natural number greater than 1. The instruction control unit is configured to, based on a track address of a target instruction of a branch instruction stored in a track table, control a memory with a lower speed to provide the instruction for a memory with a higher speed.

### FIELD OF THE INVENTION

The present invention generally relates to computer architecture and, more particularly, to the systems and methods for instruction processing.

### BACKGROUND

In today's computer architecture, a processor (also known as the CPU) is a core device. The processor may be General Processor, central processing unit (CPU), Microprogrammed Control Unit (MCU), digital signal processor (DSP), graphics processing unit (GPU), system on a chip (SOC), application specific integrated circuits (ASIC), etc. In general, the processor is hardware within a computer that carries out a plurality of instructions of a computer program by performing the basic arithmetical, logical, and input/output operations of the system. Therefore, memory needs to store data and instructions for processing.

Current instruction processing system generally includes a processor and multi-level memory system. The multi-level memory hierarchy generally includes multiple memory devices with different access speeds. For example, a two level memory system generally includes a first level memory and a second level memory. The first level memory is faster than the second level memory. But memory space/area/capacity size of the first level memory is smaller than memory space/area/capacity size of the second level memory. That is, the first level memory is generally faster in speed while smaller in size/capacity than the second level memory.

For CPU to execute an instruction, at the beginning, CPU needs to read the instruction and/or data from the first level memory. The CPU is capable of being coupled to the first level memory with a faster speed. But maybe the first level memory does not store the instruction requested from the CPU because capacity of the first level memory is smaller than the second level memory. At this time, in the two level memory system, the required instruction is stored in the second level memory. But the second level memory with a slower speed than the first level memory, thus an instruction access process causes slow down execution speed of the CPU.

In general, instructions may include branch instructions and non-branch instructions. The subsequent instruction of the non-branch instruction is always the next instruction executed in sequence. Therefore, the subsequent instruction can be stored in the first level memory in advance according to temporal locality and spatial locality. But the branch instruction cannot be stored in the first level memory in advance because an unordered branch/jump occurs.

As can be seen, in the current instruction processing system, the first level memory cannot provide the required instructions for the CPU in time. Especially when processing branch instructions, conventional processors often do not know where to fetch the next instruction after a branch instruction and may have to wait until the branch instruction finishes. Thus, under this branch taken successfully scenario, the computer system may cause significant performance decrease.

The disclosed system and method are directed to solve one or more problems set forth above and other problems.

### BRIEF SUMMARY OF THE DISCLOSURE

One aspect of the present disclosure includes an instruction processing system. The system includes a central processing unit (CPU), an m number of memory devices and an instruction control unit. The CPU is capable of being coupled to the m number of memory devices. Further, the CPU is configured to execute one or more instructions of the executable instructions. The m number of memory devices with different access speeds are configured to store the instructions, where m is a natural number greater than 1. The instruction control unit is configured to, based on a track address of a target instruction of a branch instruction stored in a track table, control a memory with a lower speed to provide the instruction for a memory with a higher speed.

Another aspect of the present disclosure includes an instruction processing method. The method includes calculating a block address of a target instruction of a branch instruction of instructions provided by a memory. The method also includes obtaining a row number of the track address corresponding to the target instruction after performing a matching operation on the block address of the target instruction of the branch instruction. Further, the method includes obtaining a column number of the track address corresponding to the target instruction by an offset of the target instruction in the instruction block. The method includes controlling a memory with a lower speed to provide the instruction for a memory with a higher speed based on a track address of a target instruction of a branch instruction stored in a track table.

Other aspects of the present disclosure can be understood by those skilled in the art in light of the description, the claims, and the drawings of the present disclosure.

### BRIEF DESCRIPTION OF THE DRAWINGS

FIG. 1 illustrates a structure schematic diagram of an exemplary instruction processing system consistent with the disclosed embodiments;

FIG. 2 illustrates another structure schematic diagram of an exemplary instruction processing system consistent with the disclosed embodiments;

FIG. 3 illustrates a structure schematic diagram of an exemplary predictor consistent with the disclosed embodiments;

FIG. 4A-4D illustrate a tree structure schematic diagram of a branch instruction and a branch instruction segment consistent with the disclosed embodiments;

FIG. 4E illustrates a schematic diagram of change situation of four registers of an exemplary predictor consistent with the disclosed embodiments;

FIG. 5 illustrates a structure schematic diagram of an exemplary prediction tracker consistent with the disclosed embodiments;

FIG. 6 illustrates a structure schematic diagram of an exemplary buffer consistent with the disclosed embodiments;

FIG. 7 illustrates a structure schematic diagram of an exemplary buffer with temporary storage consistent with the disclosed embodiments; and

FIG. 8 illustrates another structure schematic diagram of an exemplary instruction processing system consistent with the disclosed embodiments;

FIG. 9 illustrates a structure schematic diagram of calculating and searching a branch instruction consistent with the disclosed embodiments;

FIG. 10A illustrates a structure schematic diagram of an exemplary entry of an active list consistent with the disclosed embodiments;

FIG. 10B illustrates a content schematic diagram of an exemplary entry of an track table consistent with the disclosed embodiments;

FIG. 11 illustrates a schematic diagram of an exemplary branch instruction address and an exemplary branch target instruction address consistent with the disclosed embodiments;

FIG. 12 illustrates a structure schematic diagram of an exemplary branch target address calculated by a scanner consistent with the disclosed embodiments;

FIG. 13 illustrates a schematic diagram of an exemplary preparing data for data access instruction in advance consistent with the disclosed embodiments;

FIG. 14 illustrates a structure schematic diagram of an exemplary translation lookaside buffer (TLB) between a CPU and an active list consistent with the disclosed embodiments;

FIG. 15 illustrates a structure schematic diagram of an exemplary virtual address to physical address translation consistent with the disclosed embodiments;

FIG. 16 illustrates another structure schematic diagram of an exemplary virtual address to physical address translation consistent with the disclosed embodiments;

FIG. 17 illustrates another structure schematic diagram of calculating a branch target address consistent with the disclosed embodiments;

FIG. 18 illustrates another structure schematic diagram of an exemplary virtual address to physical address translation consistent with the disclosed embodiments;

FIG. 19 illustrates a schematic diagram of an exemplary instruction type consistent with the disclosed embodiments; and

FIG. 20 illustrates a structure schematic diagram of an exemplary instruction processing system consistent with the disclosed embodiments.

### DETAILED DESCRIPTION

Reference will now be made in detail to exemplary embodiments of the invention, which are illustrated in the accompanying drawings. The same reference numbers may be used throughout the drawings to refer to the same or like parts.

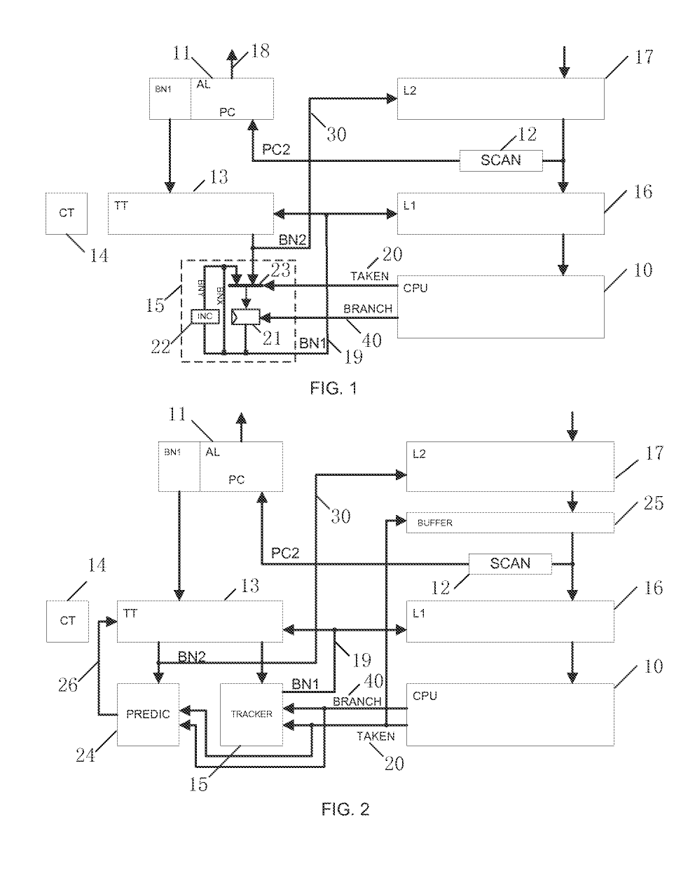

FIG. 1 illustrates a structure schematic diagram of an exemplary instruction processing system consistent with the disclosed embodiments. As shown in FIG. 1, the instruction processing system may include a CPU 10, an active list 11, a scanner 12, a track table 13, a correlation table 14, a tracker 15, a level one cache 16 (i.e., a first level memory, that is, a memory with the fastest access speed), and a level two cache 17 (i.e., a second level memory, that is, a memory with the lowest access speed). It is understood that the various components are listed for illustrative purposes, other components may be included and certain components may be combined or omitted. Further, the various components may be distributed over multiple systems, may be physical or virtual components, and may be implemented in hardware (e.g., integrated circuit), software, or a combination of hardware and software.

As used herein, the level of a memory refers to the closeness of the memory in coupling with CPU 10. The closer a memory is located to the CPU, the higher level the memory is. Further, a higher level memory (i.e., level one cache 16) is generally faster in speed while smaller in size than a lower level memory (i.e., level two cache 17). In general, the memory that is closest to the CPU refers to the memory with the fastest speed, such as level one cache (L1 cache) 16. In addition, the relation among all levels of memory is an inclusion relation, that is, the lower level memory contains all storage content of the higher level memory.

A branch instruction or a branch point, as used herein, refers to any appropriate type of instruction which may cause CPU 10 to change an execution flow (e.g., executing an instruction out of sequence). A branch source may refer to an instruction that is used to execute a branch operation (i.e., a branch instruction), and a branch source address may refer to the address of the branch instruction itself. A branch target may refer to a target instruction being branched to when the branch instruction is taken, and a branch target address may refer to the address being branched to if the branch is taken successfully, that is, an instruction address of the branch target instruction. A current instruction may refer to an instruction being currently executed or fetched by CPU 10. A current instruction block may refer to an instruction block containing an instruction being currently executed by CPU 10. A fall-through instruction may refer to the next instruction of a branch instruction if the branch is not taken or is not taken successfully.

The rows in track table 13 and cache blocks in L1 cache 16 may be in one to one correspondence. The track table 13 includes a plurality of track points. A track point is a single entry in the track table 13 containing information of at least one instruction, such as instruction type information, branch target address, etc.

As used herein, a track address of the track point is a track table address of the track point, and the track address is constituted by a row number and a column number. The track address of the track point corresponds to the instruction address of the instruction represented by the track point. The track point (i.e., branch point) of the branch instruction contains the track address of the branch target instruction of the branch instruction in the track table, and the track address corresponds to the instruction address of the branch target instruction.

For illustrative purposes, BN represents a track address. BNX represents a row number of the track address or a block address, and BNY represents a column number of the track address or a block offset address. Thus, track table 13 may be configured as a two dimensional table with X number of rows and Y number of columns, in which each row, addressable by BNX, corresponds to one memory block or memory line, and each column, addressable by BNY, corresponds to the offset of the corresponding instruction within memory blocks. Accordingly, each BN containing BNX and BNY also corresponds to a track point in the track table 13. That is, a corresponding track point can be found in the track table 13 according to one BN. Further, BN1 represents the track address of the corresponding L1 cache, and BN2 represents the track address of the corresponding L2 cache.

When an instruction corresponding to a track point is a branch instruction (in other words, the instruction type information of the track point indicates the corresponding instruction is an branch instruction), the track point also stores position information of the branch target instruction of the branch instruction in the memory that is indicated by a track address (L1 cache 16 or L2 cache 17). Based on the track address, the position of a track point corresponding to the branch target instruction can be found in the track table 13. For the branch point of the track table 13, the track table address is the track address corresponding to the branch source address, and the content of the track table contains the track address corresponding to the branch target address.

In certain embodiments, a total entry number of active list 11 is the same as a total cache block number of L2 cache 17 such that a one-to-one relationship can be established between entries in active list 11 and cache blocks in L2 cache 17. Every entry in active list 11 corresponds to one BN2X indicating the position of the cache block stored in L2 cache 17 corresponding to the row of active list 11, thus a one-to-one relationship can be established between BN2X and cache block in L2 cache 17. Each entry in active list 11 stores a block address of the L2 cache block. In addition, every entry in active list 11 also contains the information on whether all or part of the cache block of the L2 cache is stored in L1 cache 16. When all or part of the cache block of L2 cache is stored in L1 cache 16, every entry of the active list 11 corresponding to the cache block of the L2 cache stores the block number (i.e. BN1X of BN1) of the corresponding L1 cache block. Thus, when an instruction address is used to perform a matching operation in active list 11, BN1X stored in the matched entry, BN2X corresponding to the matched entry, or a result indicating that the match is unsuccessful can be obtained.

The scanner 12 may examine every instruction sent from L2 cache 17 to L1 cache 16. If the scanner 12 finds an instruction is a branch instruction, the branch target address of the branch instruction is calculated. For example, the branch target address may be calculated by the sum of the block address of the instruction block containing the branch instruction, the block offset of the instruction block containing the branch instruction, and a branch offset.

The branch target instruction address calculated by the scanner 12 matches with the row address of the memory block stored in the active list 11. If there is a match and the corresponding BN1X is found (that is, it indicates that the branch target instruction is stored in L1 cache 16), the active list 11 outputs the BN1X to the track table 13. If there is a match, but the corresponding BN1X is not found (that is, it indicates that the branch target instruction is stored in L2 cache 17, but is not stored in L1 cache 16), the active list 11 outputs BN2X to the track table 13. If there is no match (that is, it indicates that the branch target instruction is not stored in L1 cache 16 and L2 cache 17), the branch target instruction address is sent to an external memory via bus 18. At the same time, one entry is assigned in active list 11 to store the corresponding block address. The BN2X is outputted and sent to the track table 13. The corresponding instruction block sent from the external memory is filled to the cache block corresponding to the BN2X in L2 cache 17.

When an instruction block outputted from L2 cache 17 is written to a cache block of L1 cache 16, the corresponding track is built in the corresponding row of the track table 13. The branch target instruction address of the branch instruction in the instruction block outputs a BN1X or BN2X after the matching operation is performed in the active list 11. The position of the branch target instruction in the instruction block (i.e. the offset of the branch target instruction address) is the corresponding BN1Y or BN2Y. Thus, the track address (i.e. BN1 or BN2) corresponding to the branch target instruction is obtained. The track address as the content of the track point is stored in the track point corresponding to the branch instruction.

Therefore, a track corresponding to the instruction block is established. The track address in the content of track point of the track table 13 may be BN1 or BN2. BN1 and BN2 correspond to the instruction block stored in L1 cache 16 and L2 cache 17, respectively.

The tracker 15 includes a register 21, an incrementer 22, and a selector 23. Register 21 stores track addresses. The output of the register 21 is read pointer 19 of the tracker 15. The read pointer 19 points to a track point of the track table 13. When an instruction type read out by the read pointer 19 from the track table 13 is a non-branch instruction type, the BNX part of the track address of the register 21 is kept unchanged, but the BNY part of the track address is added 1 by incrementer 22 and is sent to selector 23. Because a TAKEN signal 20 representing whether branch is taken is invalid at this time, selector 23 selects the default input. That is, the BNY added 1 is written back to register 21 such that the read pointer 19 moves and points to the next track point.

The read pointer 19 moves until the read pointer 19 points to a branch instruction. That is, the value of the read pointer 19 is a track address of the branch source instruction. The track address of the branch target instruction of the branch source instruction read out from the track table 13 is sent to the selector 23. Another input of the selector 23 is still the track address added 1 and outputted by the read pointer 19 (that is, the read pointer 19 points to the track address of the track point after the branch point).

Thus, the read pointer 19 of the tracker 15 moves in advance from the track point corresponding to the instruction executed currently by the CPU 10 to the first branch point after the track point. Because the track address contained in the content of the track point in the track table 13 may be BN1 or BN2 based on the different position of the corresponding target instruction in the memory, the target instruction may be found in the cache memory (L1 cache or L2 cache) based on the track address of the target instruction.

When the content of the track point pointed to by the read pointer 19 of the tracker 15 is BN2, the BN2 is sent to L2 cache 17 via bus 30 such that the corresponding instruction block can be found and filled to L1 cache 16. At the same time, the track corresponding to the instruction block is established in the track table 11, and the content of the track point pointed to by the read pointer 19 of the tracker 15 is replace by the corresponding BN1 instead of the original BN2.

When CPU 10 executes the branch instruction, a TAKEN signal 20 is generated. If the TAKEN signal 20 indicates that the branch is not taken, the selector 23 selects the track address added 1 by the read pointer 19, and the track address is written back to register 21. The read pointer 19 continues to move along the current track to the next branch point. Further, the CPU 10 outputs the offset of instruction address to read the corresponding subsequent instruction from the cache block of L1 cache 16 pointed to by the read pointer 19.

If the TAKEN signal 20 indicates that the branch is taken, the selector 23 selects the track address of the branch target instruction outputted by the track table 13, and the track address is written back to register 21. The read pointer 19 points to the track point corresponding to the branch target instruction of the track table 13 and the branch target instruction of L1 cache 16 such that the branch target instruction can be directly found from L1 cache 16 based on the track address BN1 outputted by the read pointer 19. Therefore, the branch target instruction is outputted for CPU 10 to execute. According to the previous method, the read pointer 19 continues to move along the new current track to the next branch point. Further, the CPU 10 outputs the offset of instruction address to read the corresponding subsequent instruction from the cache block of L1 cache 16 pointed to by the read pointer 19.

Thus, when CPU 10 needs to fetch an instruction, the corresponding instruction has already been stored in L1 cache 16 or is being filled to L1 cache 16. Therefore, all or part of waiting time caused by cache missing is hidden, improving the performance of the instruction processing system.

It should be noted that an end track point may be added after the last track point of every track in the track table 13. The type of the end track point is a branch that is bound to take. BNX of the content of the end point is row number (BNX) of the next instruction block of the instruction block corresponding to the track in the track table 13. BNY of the content of the end point is ‘0’. Thus, if the tracker 15 starts to move from the last branch point of the track, the pointer points to the end track point and moves to the next instruction block. BNX and BNY may be used for instructions and/or data. However, for data, data row number or data block number (DBNX) and data column number or data block offset number (DBNY) may be used.

A correlation table 14 may be established to indicate the correlative relationship between tracks in track table 13, such as branching among different rows. The track without a branch target is selected and replaced in the track table 13. Or when one track in track table 13 needs to be replaced, the content (i.e., the branch target track address) of the corresponding branch source is updated, preventing errors (e.g. the content of the track point of the corresponding branch source points to the track point of the wrong branch target) from happening.

In addition, the structure can also be extended to an instruction processing system with m layers of memory (cache), where m is a natural number greater than or equal to 2; m is equal to 2 in FIG. 1.

If delay of filling instructions blocks from L2 cache 17 to L1 cache 16 is very long, the track addresses of target instructions of more layer branch instructions can be found in advance, the corresponding target instructions is filled earlier from L2 cache 17 to L1 cache 16. Thus, when CPU 10 needs to read corresponding instructions, these instructions have already stored in L1 cache 16, thereby better hiding waiting time caused by cache misses.

The instruction processing system also includes a predictor. The predictor is configured to obtain a branch instruction segment after the branch instruction segment pointed to by the tracker. That is, the predictor is configured to obtain the nth layer of branch instruction segment after the first layer of branch instruction segment, and control a memory device with a lower speed to provide the nth layer of branch instruction segment that is not stored in a memory device with a higher speed for the memory device with a higher speed, where n is a natural number.

FIG. 2 illustrates another structure schematic diagram of an exemplary instruction processing system consistent with the disclosed embodiments. As shown in FIG. 2, the instruction processing system may include a CPU 10, an active list 11, a scanner 12, a track table 13, a correlation table 14, a tracker 15, a level one cache (L1 cache) 16, a level two cache (L2 cache) 17, a predictor 24, and a buffer 25.

The track table 13 may output the content of two corresponding track points at the same time based on two track addresses. One track address is from read pointer 19 of the tracker 15, and the other track address is from bus 26 outputted by the predictor 24.

The predictor 24 is configured to obtain the nth layer of branch instruction segment after the first layer of branch instruction segment, and output the track address of the nth layer of branch instruction segment after the first layer of branch instruction segment to the track table 13 via bus 26. If the track address is BN2, a corresponding instruction block is read out from L2 cache 17 in advance based on BN2 and is temporarily stored in buffer 25. If the track address is BN1, no additional operation is needed. In addition, the BN value corresponding to every instruction segment stored in buffer 25 is also stored in buffer 25. As used herein, every instruction segment has only one branch instruction. Specifically, every branch instruction and all instructions before the previous branch instruction (not including the previous branch instruction) belong to an instruction segment. Because the output pointer of the tracker or predictor stops at the branch instruction, “the track address of the instruction segment” is equal to “the track address of the branch instruction in the instruction segment”. “branch instruction segment”, “the next instruction segment” and “target instruction segment” belong to “the instruction segment” defined here.

Thus, the branch target instruction blocks of n layers of branch instructions after the branch instruction pointed to by the read pointer 19 of the tracker 15 are stored in L1 cache 16 or buffer 25 using the predictor 24 in advance. Based on the execution result of the branch instruction pointed to by read point 19 executed by CPU 10, some instruction blocks of buffer 25 are filled to L1 cache 16.

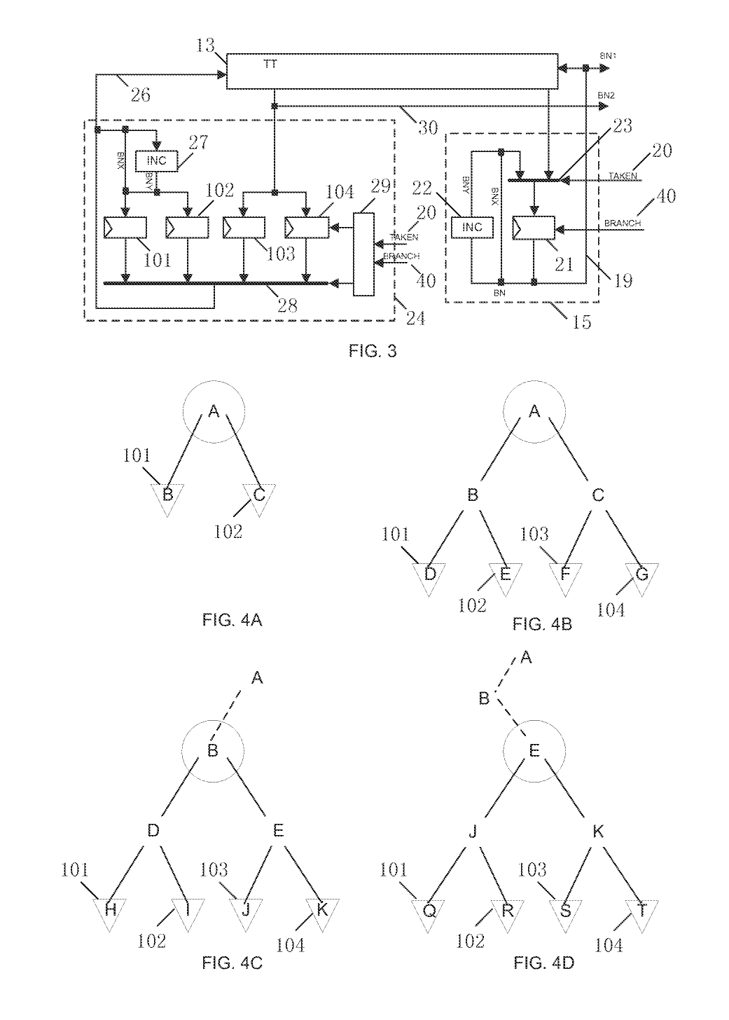

FIG. 3 illustrates a structure schematic diagram of an exemplary predictor consistent with the disclosed embodiments. As shown in FIG. 3, a predictor 24 is configured to obtain the track address of the second layer of branch instruction segment after the first layer of branch instruction segment, where n is equal to 2.

The predictor 24 may include an incrementer 27, a selector 28, a control logic 29 and four registers. The control logic 29 receives a TAKEN signal 20 sent from CPU 10 and a BRANCH signal 40 indicating whether an instruction being executed by CPU 10 is a branch instruction (that is, the BRANCH signal 40 indicating whether the TAKEN signal 20 is valid), and generate a control signal to control the write operation of the registers and selector 28. The inputs of register 101 and register 102 are from incrementer 27, and the inputs of register 103 and register 104 are from track table 13. The outputs of the four registers are sent to selector 28. The selector 28 outputs the track address of the first layer of branch instruction segment of the first layer of branch instruction segment to track table 13 via bus 26.

Specifically, register 101 and register 102 are configured to store the next instruction segment address of the next instruction segment of the current branch instruction and the next instruction segment address of the target instruction segment of the current branch instruction. Register 103 and register 104 are configured to store the target instruction segment address of the next instruction segment of the current branch instruction and the target instruction segment address of the target instruction segment of the current branch instruction.

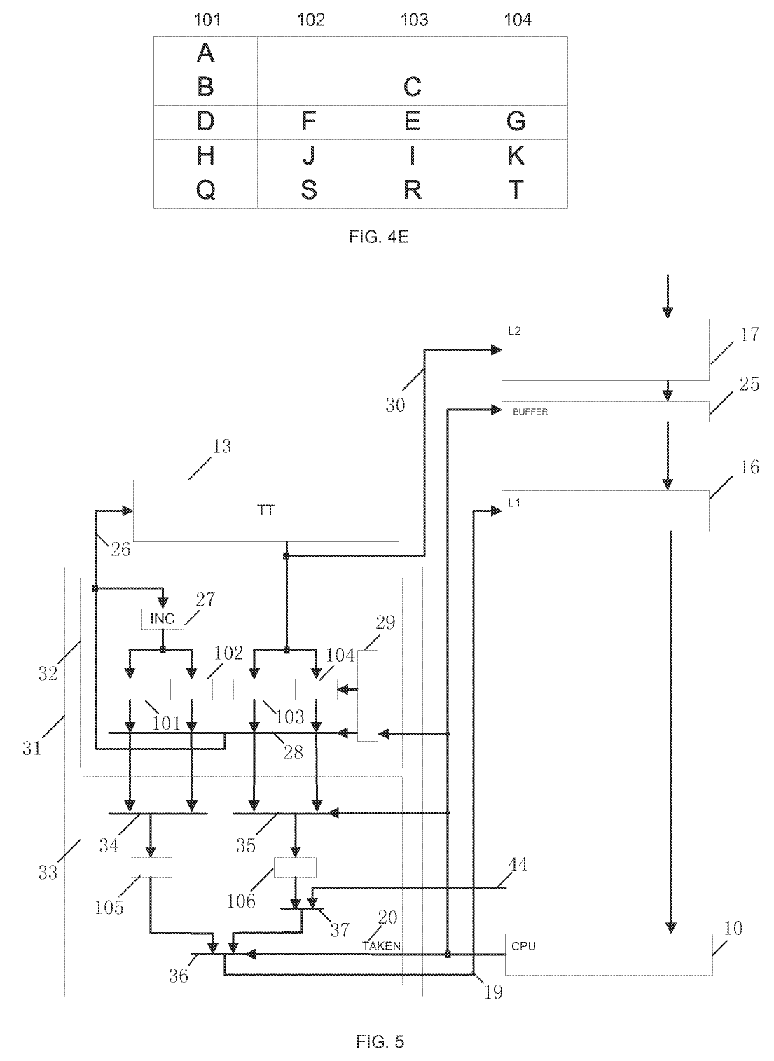

FIG. 4A-4D illustrate a tree structure schematic diagram of a branch instruction and a branch instruction segment consistent with the disclosed embodiments. As shown in FIG. 4A-4D, a node ‘A’ is an instruction segment; a left child node ‘B’ of the ‘A’ is the next instruction segment of ‘A’; and a right child node ‘C’ of the ‘A’ is a target instruction segment of ‘A’. Similarly, a left child node ‘D’ of the ‘B’ is the next instruction segment of ‘B’; and a right child node ‘E’ of the ‘B’ is a target instruction segment of ‘B’. A left child node ‘F’ of the ‘C’ is the next instruction segment of ‘C’; and a right child node ‘G’ of the ‘C’ is a target instruction segment of ‘C’. A left child node ‘H’ of the ‘D’ is the next instruction segment of ‘D’; and a right child node ‘I’ of the ‘D’ is a target instruction segment of ‘D’. A left child node ‘J’ of the ‘E’ is the next instruction segment of ‘E’; and a right child node ‘K’ of the ‘E’ is a target instruction segment of ‘E’. A left child node ‘Q’ of the ‘J’ is the next instruction segment of ‘J’; and a right child node ‘R’ of the ‘J’ is a target instruction segment of ‘J’. A left child node ‘S’ of the ‘K’ is the next instruction segment of ‘K’; and a right child node ‘T’ of the ‘K’ is a target instruction segment of ‘K’.

In addition, in FIG. 4A-4D, a triangle label corresponds to the register in predictor 24. The triangle label represents the track address corresponding to the instruction segment stored in the register. FIG. 4E illustrates a schematic diagram of change situation of four registers of an exemplary predictor consistent with the disclosed embodiments. As shown in FIG. 4E, every column corresponds to a register of predictor 24. That is, the first column corresponds to register 101; the second column corresponds to register 102; the third column corresponds to register 103; the fourth column corresponds to register 104. Every row corresponds to an update in FIG. 4A-4D.

First of all, the instruction starts to run from the current instruction segment ‘A’. At this time, as shown in the first row of FIG. 4E, the track address of ‘A’ is stored in register 101.

Then, as shown in FIG. 4A and the second row of FIG. 4E, based on the track address of ‘A’ that is stored in register 101, the track address of the target instruction segment ‘C’ of ‘A’ is read out from the track table 13, and is stored in register 103. At the same time, the track address of ‘A’ is cumulated to get the track address of the next instruction segment ‘B’ of ‘A’ using the incrementer 27, and the obtained track address is stored in register 101.

Further, as shown in FIG. 4B and the third row of FIG. 4E, based on the track address of ‘C’ that is stored in the register 103, the track address of the target instruction segment ‘G’ of ‘C’ is read out from the track table 13, and is stored in register 104. At the same time, the track address of ‘C’ is cumulated to get the track address of the next instruction segment ‘F’ of ‘C’ using the incrementer 27, and the obtained track address is stored in register 102. Based on the track address of ‘B’ that is stored in the register 101, the track address of the target instruction segment ‘E’ of ‘B’ is also read out from the track table 13, and is stored in register 103. At the same time, the track address of ‘B’ is cumulated to get the track address of the next instruction segment ‘D’ of ‘B’ using the incrementer 27, and the obtained track address is stored in register 101.

Thus, four register values in the predictor 24 are generated. These four registers values correspond to the track addresses of the second-level branch instruction segment after the branch instruction of ‘A’, respectively.

Returning to FIG. 3, when CPU 10 executes the branch instruction of ‘A’ and generates the TAKEN signal 20, based on the value of the TAKEN signal 20, control logic 29 generates the corresponding control signal to update the four register values. When TAKEN signal 20 indicates that the branch is not taken, control logic 29 controls selector 28 to select the track addresses of register 101 and register 103 as outputs to generate the track addresses of the subsequent instruction segment, and to discard the track addresses corresponding to ‘F’ and ‘G’ stored in register 102 and register 104.

Specifically, as shown in FIG. 4C and the fourth row of FIG. 4E, based on the track address of ‘E’ that is stored in the register 103, the track address of the target instruction segment ‘K’ of ‘E’ is read out from the track table 13, and is stored in register 104. At the same time, the track address of ‘E’ is cumulated to get the track address of the next instruction segment ‘J’ of ‘E’ using the incrementer 27, and the obtained track address is stored in register 102. Based on the track address of ‘D’ that is stored in the register 101, the track address of the target instruction segment ‘I’ of ‘D’ is read out from the track table 13, and is stored in register 103. At the same time, the track address of ‘D’ is cumulated to get the track address of the next instruction segment ‘H’ of ‘D’ using the incrementer 27, and the obtained track address is stored in register 101. Thus, based on execution result of the branch instruction in ‘A’, four register values in the predictor 24 are updated. That is, these four register values correspond to the track addresses of the second-level branch instruction segment after the branch instruction of ‘B’, respectively.

Then, when CPU 10 executes the branch instruction of ‘B’ and generates the TAKEN signal 20, if the TAKEN signal 20 indicates that the branch is taken successfully, control logic 29 controls selector 28 to select the track addresses of register 102 and register 104 as outputs to generate the track addresses of the subsequent instruction segment, and to discard the track addresses corresponding to ‘H’ and ‘I’ stored in register 101 and register 103.

Specifically, as shown in FIG. 4D and the fifth row of FIG. 4E, based on the track address of ‘J’ that is stored in the register 102, the track address of the target instruction segment ‘R’ of ‘J’ is read out from the track table 13, and is stored in register 103. At the same time, the track address of ‘J’ is cumulated to get the track address of the next instruction segment ‘Q’ of ‘J’ using the incrementer 27, and the obtained track address is stored in register 101. Based on the track address of ‘K’ that is stored in the register 104, the track address of the target instruction segment ‘T’ of ‘K’ is read out from the track table 13, and is stored in register 104. At the same time, the track address of ‘K’ is cumulated to get the track address of the next instruction segment ‘S’ of ‘K’ using the incrementer 27, and the obtained track address is stored in register 102. Thus, based on execution result of the branch instruction in ‘B’, four register values in the predictor 24 are updated. That is, these four register values correspond to the track addresses of the second-level branch instruction segment after the branch instruction of ‘E’, respectively.

During these operations, predictor 24 points to instruction segments two branch levels ahead of tracker 15. Once predictor 24 finds that the track address of the described instruction segment is BN2, the corresponding instructions are read out from the L2 cache 17 via bus 30 and stored in buffer 25. Based on the TAKEN signal 20, buffer 25 selects the instruction block to fill to the L1 cache 16, and BN2 of the content of the branch point in the track table 13 is replaced by BN1. Therefore, when the read pointer of tracker 15 points to the branch point, the track address of the target instruction that is read out is BN1. Thus, if the time period that the instruction segment from the L2 cache 17 is filled to buffer 25 and the instruction segment from buffer 25 is filled to L1 cache 16 is not greater than the time difference between the time point that the filling operation starts and the time point that the CPU reaches the instruction segment, the instruction segments requested by CPU (the next instruction segment and the target instruction segment) have been stored in the L1 cache 16. Whether or not the branch is taken for a branch instruction corresponding to the branch point executed by CPU 10, the next instruction may be read out from the L1 cache 16, avoiding cache misses. Otherwise, although the instruction segments requested by CPU have not been stored in the L1 cache 16, the instruction segments have already been in the filling process, hiding partial waiting time caused by cache misses.

A prediction tracker can also be used to perform functions of tracker 15 and predictor 24. FIG. 5 illustrates a structure schematic diagram of an exemplary prediction tracker consistent with the disclosed embodiments. As shown in FIG. 5, the prediction tracker 31 includes a prediction section 32 and a clip section 33. Track table 13 only needs to output the content of the corresponding track point based on a track address. That is, track table 13 needs only a read-only port. The clip section 33 outputs read pointer 19 to implement function of tracker 15. The prediction section 32 obtains the track address of the second layer of branch instruction segment after the first layer of branch instruction segment (that is, n is equal to 2) to implement functions of predictor 24. The structure and working procedures of the prediction section 32 are the same as the above described predictor 24, which is not repeated here.

The clip section 33 includes a register 105, a register 106, a selector 34, a selector 35, a selector 36 and a selector 37. Selector 34 and selector 35 receive the track addresses of the second layer of branch instruction segment after the first layer of branch instruction segment stored in four registers of the prediction section 32, respectively. Base on TAKEN signal 20, the track addresses are clipped in half After clipping, the remaining track addresses are stored in register 105 and register 106, respectively. Because the next instruction segment of the branch instruction segment and BNX of track address of the branch instruction segment are the same (i.e. BN1X), therefore only BN2X that may appear in the track address of the target instruction segment needs to be replaced by BN1X. When the instruction segment (i.e. the instruction segment corresponding to BN2) stored in buffer 25 is filled to L1 cache 16, according to a certain replacement policy, a BN1 can be assigned to store the instruction segment. Therefore, when the track address outputted by selector 35 is BN2, selector 37 selects the newly assigned BN1 from bus 44 as its output; when the track address outputted by selector 35 is BN1, selector 37 selects the track address temporally stored in register 106 as its output. Based on TAKEN signal 20, selector 36 selects one track address from the track address outputted by selector 37 and the track address stored in register 105 as read pointer 19. The selected track address is sent to L1 cache 16 to find the corresponding instruction block for CPU 10.

For the situation described in FIG. 4A˜4E, as shown in FIG. 4B and the third row of FIG. 4E, four register values in the prediction section 32 are generated by the above described methods. At this time, four inputs of the clip section 33 are the track addresses of ‘D’, ‘F’, ‘E’ and ‘G’ from left to right, respectively. The track address of ‘B’ is stored in register 105 of the clip section 33; the track address of ‘C’ is stored in register 106 of the clip section 33. The value of read pointer 19 is the track address of ‘A’.

When TAKEN signal 20 generated by the branch instruction of ‘A’ executed by CPU 10 indicates that the branch is not taken, selector 36 selects input ‘B’ of register 105 as the value of read pointer 19. The value of read pointer 19 is sent to L1 cache 16 to find the corresponding instruction block for CPU 10, and the track address of ‘C’ is clipped and discarded. At the same time, selector 34 of the clip section 33 selects the input ‘D’ from register 101 and writes the input ‘D’ to register 105. Selector 35 selects the input ‘E’ from register 103 and writes the input ‘E’ to register 106. Thus, the track address of the subsequent instruction segment of ‘B’ is kept, and the track address of the subsequent instruction segment of ‘C’ is clipped and discarded. As shown in FIG. 4C and the fourth row of FIG. 4E, the prediction section 32 updates four register values by the above described method. At this time, four inputs of the clip section 33 are the track addresses of ‘H’, ‘J’, ‘I’ and ‘K’ from left to right, respectively.

When TAKEN signal 20 generated by the branch instruction of ‘B’ executed by CPU 10 indicates that the branch is taken successfully, selector 34 of the clip section 33 selects the input ‘J’ from register 102 and writes the input ‘J’ to register 105. Selector 35 selects the input ‘K’ from register 104 and writes the input ‘K’ to register 106. Thus, the track address of the subsequent instruction segment of ‘E’ is kept, and the track address of the subsequent instruction segment of ‘D’ is clipped and discarded. At the same time, selector 36 selects input ‘E’ from register 106 as the value of read pointer 19. The value of read pointer 19 is sent to L1 cache 16 to find the corresponding instruction block for CPU 10, and the track address of ‘C’ is clipped and discarded. As shown in FIG. 4D and the fifth row of FIG. 4E, the prediction section 32 updates four register values by the above described method.

The prediction tracker 31 can implement functions of tracker 15 and predictor 24.

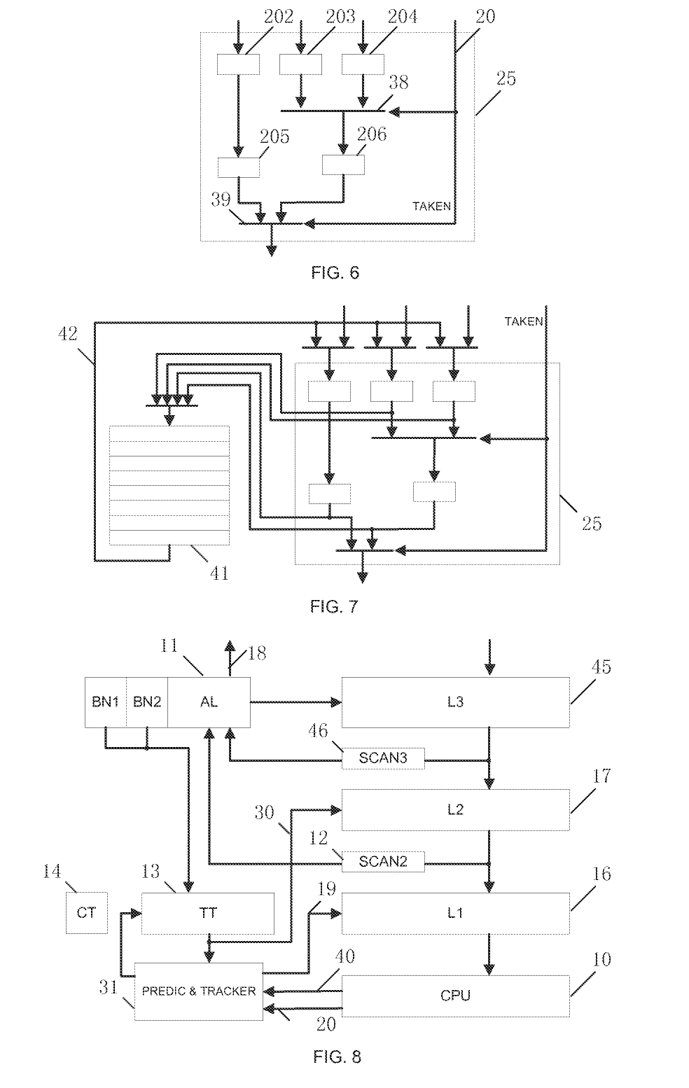

FIG. 6 illustrates a structure schematic diagram of an exemplary buffer consistent with the disclosed embodiments. As shown in FIG. 6, buffer 25 includes a register 202, a register 203, a register 204, a register 205, a register 206, a selector 38 and a selector 39. The structure of buffer 25 is similar to prediction tracker 31, and some modules of buffer 25 may be omitted.

Register 202, register 203, register 204, register 205, register 206 are configured to store instruction blocks. Register 202 stores the instruction block containing the instruction segment corresponding to register 102 of the prediction section 32; register 203 stores the instruction block containing the instruction segment corresponding to register 103 of the prediction section 32, register 204 stores the instruction block containing the instruction segment corresponding to register 104 of the prediction section 32; register 205 stores the instruction block containing the instruction segment corresponding to register 105 of the prediction section 32; register 206 stores the instruction block containing the instruction segment corresponding to register 106 of the prediction section 32. The instruction segment corresponding to the track address of register 101 of the prediction section 32 is the instruction segment being executed by CPU 10, and the instruction is stored in the L1 cache 16. Therefore, buffer 25 does not need to include a register that is used to store the instruction segment corresponding to the track address of register 101. Similarly, as long as CPU 10 generates TAKEN signal 20, regardless of whether the branch is taken, the instruction blocks of register 202 are written to register 205.

The functions of selector 38 are similar to functions of selector 35 in the clip section 33, and selector 38 is also controlled by TAKEN signal 20. When the selector 35 selects the track address from register 103, selector 38 selects the instruction block from register 203; when the selector 35 selects the track address from register 104, selector 38 selects the instruction block from register 204.

The functions of selector 39 are similar to functions of selector 36 in the clip section 33, and selector 39 is also controlled by TAKEN signal 20. When the selector 36 selects the track address from register 105, selector 39 selects the instruction block from register 205; when the selector 36 selects the track address from register 106, selector 39 selects the instruction block from register 206.

Thus, the instruction blocks stored in buffer 25 may be in term pruned in accordance with the branch decision of the various branch instructions executed by CPU 10. The remaining instruction block after the pruning is the instruction block that will be executed by CPU 10, and this instruction block is filled to L1 cache 16.

It should be noted that buffer 25 is not a necessary component. When the instruction processing system does not contain buffer 25, based on BN2 outputted by the predictor via bus 30, the instruction block corresponding to L2 cache 17 is directly filled to L1 cache 16, and the content BN1 of the corresponding branch point in the track table 13 is replaced by BN2. When the instruction processing system contains buffer 25, although the same quantity of instruction blocks still need to be read out from L2 cache 17, only the instruction blocks to be executed are filled from the buffer 25 to L1 cache 16, thus reducing replacement times of L1 cache 16. Therefore, data pollution (that is, unused instruction block occupies the cache block in L1 cache 16) is reduced, and the performance of the instruction processing system is improved accordingly.

In addition, the clipped and discarded instruction block of buffer 25 can also be temporarily stored in another buffer, so that the clipped and discarded instruction block can be obtained faster when it is needed for the next time. FIG. 7 illustrates a structure schematic diagram of an exemplary buffer with temporary storage consistent with the disclosed embodiments. The structure and function of buffer 25 is the same as the structure and function of buffer 25 in FIG. 6, which is not repeated here. However, the clipped and discarded instruction block of buffer 25 is sent to another buffer 41. Buffer 41 temporarily stores the clipped and discarded instruction block. Buffer 41 has smaller capacity and is close to buffer 25, therefore, when the clipped and discarded instruction block needs to be filled to buffer 25 again, a matching operation can be performed firstly in buffer 41. If there is a match, the instruction block may be directly read out and sent to buffer 25 via bus 42, avoiding a longer time delay when the instruction block is read out from L2 cache 17. The times of accessing L2 cache is also reduced. The structure of buffer 41 can be any appropriate structure, such as a first-in first-out (FIFO) buffer, a fully associative structure, a set associative structure, and so on.

According to the described technical solutions, the described structure in the above embodiments can be extended to more levels memory (cache) instruction processing system. FIG. 8 illustrates another structure schematic diagram of an exemplary instruction processing system consistent with the disclosed embodiments. As used herein, m is the number of levels and is equal to 3. For other values of m (i.e. m is a nature number and larger than 3), the structure of the instruction processing system is similar to the structure of the instruction processing system shown in FIG. 8.

As shown in FIG. 8, the instruction processing system may include a CPU 10, an active list 11, a scanner 12, a track table 13, a correlation table 14, a prediction tracker 31, a L1 cache 16, a L2 cache 17, a level three cache (L3 cache) 45, and a second scanner 46.

The prediction track 31 may be replaced by tracker 15 and predictor 24 in FIG. 2. L1 cache 16, L2 cache 17 and L3 cache 45 together constitute three-level storage system (that is, m is equal to 3).

Active list 11 corresponds to the outermost cache (i.e. L3 cache). That is, a one-to-one relationship can be established between entries in active list 11 and cache blocks in L3 cache. Every entry corresponds to a BN3X, indicating the position of the L3 cache block corresponding to the row of active list 11 stored in L3 cache 45, thus a one-to-one relationship can be established between BN3X and the cache block in L3 cache. Every entry in active list 11 stores a block address of the L3 cache block.

In addition, every entry in the active list 11 also contains the information on whether all or part of the L3 cache block is stored in L1 cache 16 and L2 cache 17. When all or part of a L3 cache block is stored in L1 cache 16, the entry in active list 11 corresponding to the instruction block of the L3 cache stores the block number (i.e. BN1X of BN1) of the corresponding L1 cache block. Similarly, when all or part of an L3 cache block is stored in L2 cache 17, the entry in active list 11 corresponding to the instruction block of the L3 cache stores the block number (i.e. BN2X of BN1) of the corresponding L2 cache block.

Thus, when an instruction address is used to perform a matching operation in active list 11, BN1X or BN2X stored in the matched entry, BN3X corresponding to the matched entry, or a result indicating that the match is unsuccessful can be obtained.

The scanner 46 may examine every instruction sent from L3 cache 45 to L2 cache 17. If the scanner 46 finds certain instruction is a branch instruction, the branch target address of the branch instruction is calculated. The branch target instruction address matches with the row address of the memory block stored in active list 11. If there is a match and the corresponding BN2X is found, it indicates that the branch target instruction is stored in L2 cache 17, and no additional operation is performed. If there is a match and the corresponding BN2X is not found, it indicates that the branch target instruction is stored in L3 cache 45, but the branch target instruction is not stored in L2 cache 17, and active list 11 outputs the BN3X to L3 cache 45 via bus 47 such that the instruction block containing the branch target instruction is filled from L3 cache 45 to L2 cache 17. If there is no match, it indicates that the branch target instruction is not stored in L2 cache 17 and L3 cache 45, and the branch target instruction address is sent to an external memory via bus 18. At the same time, active list 11 assigns one entry to store the corresponding block address. The BNX2 is outputted and sent to the track table 13. The corresponding instruction block sent from an external memory is filled to the cache block corresponding to the BNX3 in L3 cache 45, and is filled to L2 cache 17. Thus, no matter what the match result is, all instruction blocks containing the branch target instruction of the branch instruction of the instruction blocks filled from L3 cache 45 to L2 cache 17 are filled to L2 cache 17.

The scanner 12 may examine every instruction sent from L3 cache 45 to L2 cache 17 according the above described method. If the scanner 12 finds certain instruction is a branch instruction, the branch target address of the branch instruction is calculated. The branch target instruction address matches with the row address of the memory block stored in active list 11.

The instruction blocks containing the branch target instruction of the branch instruction of the instruction block of L2 cache 17 are filled to L2 cache 17, so the matching operation must be successful. At this time, if the corresponding BN1X is found (that is, it indicates that the branch target instruction is stored in L1 cache 16), active list 11 outputs the BN1X to track table 13 as the row number of the content of the corresponding branch point such that the offset of the branch target instruction in the instruction block is the column number of the content of the corresponding branch point. If the corresponding BN1X cannot be found (that is, it indicates that the branch target instruction is stored in L2 cache 17, but the branch target instruction is not stored in L1 cache 16), active list 11 outputs the BN2X to track table 13 as the row number of the content of the corresponding branch point such that the offset of the instruction block containing the branch target instruction is the column number of the content of the corresponding branch point. Therefore, a track corresponding to being filled instruction block may be established according to the above described method.

Thus, the track address of the content of the track point in track table 13 may be either BN1 or BN2. BN1 and BN2 correspond to the instruction block stored in L1 cache 16 and L2 cache 17. According to the content read out by track table 13, the process that prediction tracker 31 controls the cache system to provide instructions for CPU 10 is the same as the process described in the previous embodiments, which is not repeated here.

Compared to previous embodiments, scanner 46 can earlier find the branch instruction of the instruction block filled from L3 cache 45 to L2 cache 17, and fills the corresponding branch target instruction to L2 cache 17, hiding time delay of providing the instruction blocks from L3 cache 45 to L2 cache 17. The same method can also be extended to more level cache instruction processing system, further hiding time delay of providing the instruction blocks from the most outer memory (cache) to the inner memory (cache), so as to better improve the performance of the instruction processing system. Other advantages and applications are obvious to those skilled in the art.

Based on the address change range, different cache memory addressing method and virtual address to physical address translation methods may be selected. For example, the address change range of two consecutive address instructions equals to ‘1’, but the address change range between a branch instruction (also called ‘a branch source instruction’) and a branch target instruction equals to a branch jump distance. For a L1 Cache, the addresses of the instruction blocks corresponding to the instructions of the same instruction block of L1 cache are the same. BN1X of the cache track addresses are the same. Therefore, if the track address BN1X of the previous instruction is known, the track address BN1X of the next instruction may be obtain directly (the track address BN1X of the next instruction does not need to perform a matching operation with the active list). Otherwise, the matching operation with the active list possibly needs to be performed.

Similarly, the virtual addresses corresponding to instructions of the same page are the same, and the physical addresses corresponding to instructions of the same page are also the same. Therefore, when the physical address of the previous instruction is known, the physical address of the next instruction may be obtained directly (a matching operation with the virtual address to physical address translation module or TLB does not need to be performed). Otherwise, the matching operation with the TLB possibly needs to be performed.

For ease of description, a memory system with a two-level cache hierarchy (L1 cache and L2 cache) is used in the following embodiments. The technical solution may also be applied to a memory system with more than two-level cache hierarchy (e.g., a three-level cache hierarchy). The detailed method may refer to the embodiment in FIG. 8, which is not repeated here.

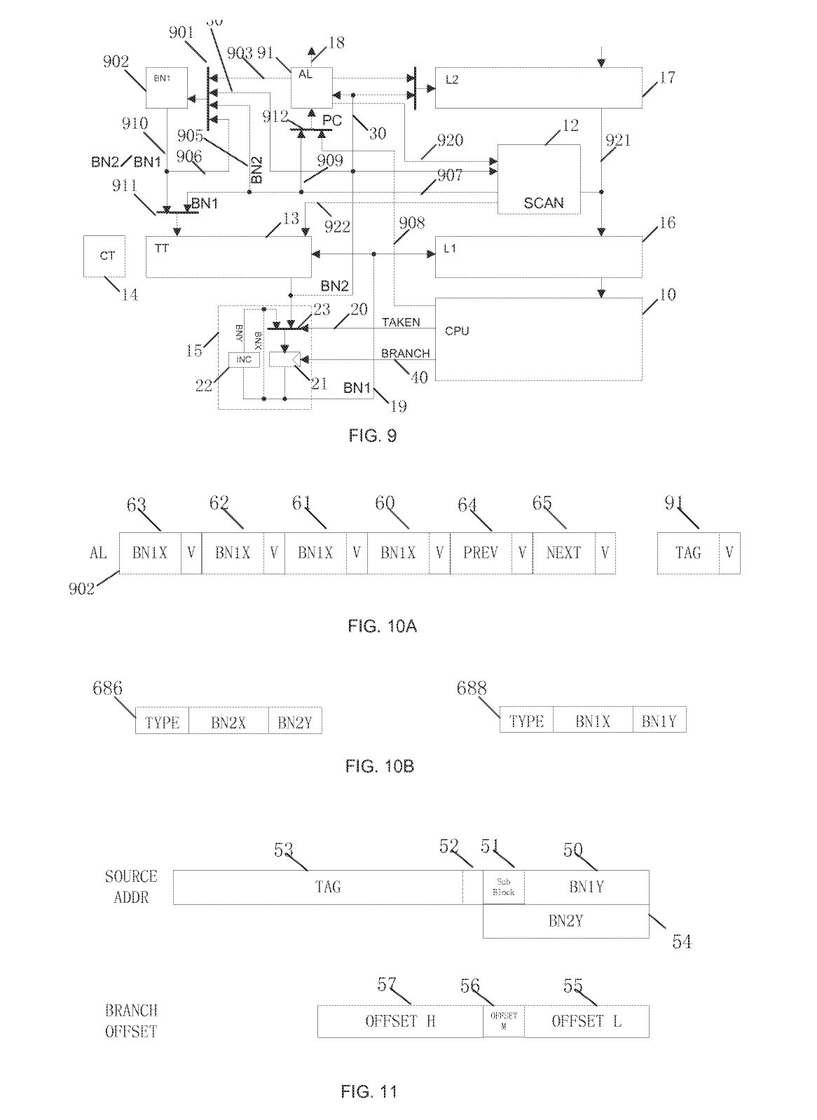

FIG. 9 illustrates a structure schematic diagram of calculating and searching a branch instruction consistent with the disclosed embodiments. As shown in FIG. 9, a scanner may calculate and obtain a target instruction address and judges the location of the target instruction address. Then, the related information is written into the track table for the CPU to use when executing the instruction.

Translation Lookaside Buffer (TLB) for translating a virtual address to a physical address is located between L2 cache 17 and a lower level memory (e.g., L3 cache 45). As used herein, all addresses in the present embodiment may be virtual addresses. Virtual address translation refers to the process of finding out which physical page maps to which virtual page.

The structure includes a CPU 10, an active list 91, a scanner 12, a track table 13, a correlation table 14, a tracker 15, a level one cache 16 (i.e., a first level memory, that is, a memory with the fastest access speed), and a level two cache 17 (i.e., a second level memory, that is, a memory with the lowest access speed). The structure also includes a multiplexer 911, a multiplexer 912, and a memory 902. It is understood that the various components are listed for illustrative purposes, other components may be included and certain components may be combined or omitted. Further, the various components may be distributed over multiple systems, may be physical or virtual components, and may be implemented in hardware (e.g., integrated circuit), software, or a combination of hardware and software.

The tracker 15 may be replaced by the predictor 24 in FIG. 2. As used herein, memory 902 as an independent module may use other addressing method except the active list matching. At this time, memory 902 and active list 91 together implement function of the active list in the previous embodiments (e.g., active list 11 in FIG. 1). In the following embodiments, memory 902 may also be used as an independent module.

Entries of active list 91 and entries of memory 902 one-to-one correspond to memory blocks in L2 cache 17. That is, every entry corresponds to a BN2X, indicating the location where a memory block corresponding to the row of active list 91 stored in L2 cache 17. Thus, a corresponding relationship between a BN2X and a memory block in L2 cache 17 is formed. Specifically, referring to FIG. 10A, FIG. 10A illustrates a structure schematic diagram of an exemplary entry of an active list consistent with the disclosed embodiments. As shown in FIG. 10A, every entry of active list 91 stores a block address 77 of a memory block of L2 cache and its valid bit. Because different programs may have the same Virtual address, every entry of active list 91 may also include a thread ID (TID) corresponding to the Virtual address.

Every entry of memory 902 contains the information on whether all or part of the cache block of the L2 cache is stored in L1 cache 16. The instruction block of a row of L2 cache 17 corresponds to four instruction blocks in L1 cache. Therefore, every entry of active list 91 also contains memory region that stores a L1 cache block number BN1X (e.g., memory region 60, 61, 62, and 63). Every memory region contains a valid bit. The valid bit indicates whether the L1 cache block number BN1X stored in the memory block is valid. In addition, memory region 64 of every entry stores BN2X information of the previous L2 instruction block of the current L2 instruction block. Memory region 65 of every entry stores BN2X information of the next L2 instruction block of the current L2 instruction block. Each of these two memory blocks has a valid bit that indicates whether the L2 cache block number BN2X stored in the memory region is valid.

Returning to FIG. 9, tracker 15 includes a register 21, an incrementer 22, and a selector 23. Register 21 stores track addresses. The read pointer 19 (i.e., the output of register 21) points to the first branch point after the instruction currently executed by CPU 10 of the track table 13 and reads out the contents of the track point.

FIG. 10B illustrates a content schematic diagram of an exemplary entry of a track table consistent with the disclosed embodiments. As shown in FIG. 10B, entry format of track table 13 is 686 or 688. Entry format 686 includes TYPE, BN2X (L2 cache block number), and BN2Y (an offset in L2 cache block). TYPE contains an instruction type address, including a non-branch instruction, a direct branch instruction, and an indirect branch instruction. TYPE also contains an address type. The address type is a L2 cache address BN2 in entry format 686. Entry format 688 includes TYPE, BN1X (L1 cache block number), and BN1Y (an offset in L1 cache block). The instruction type of entry format 688 is the same as the instruction type of entry format 686, but the address type of entry format 688 is a L1 cache address BN1.

BN1 of the read pointer 19 of tracker 15 is used to perform an addressing operation on track table 13 to read out the contents of the track point. The BN1 is also used to read out the corresponding instruction for CPU to execute by performing an addressing operation on L1 cache 16. Specifically, the contents of the track point pointed to by the read pointer 19 of tracker 15 are read out and sent to selector 23 via bus 30.

When an instruction type contained in the contents of the track point indicates that the instruction is not a branch instruction, BN1Y outputted by register 21 is added 1 by incrementer 22. Under the control of TAKEN signal 20 (the value is 0 at this time), the selector 23 selects BN1X from register 21 and BN1Y from incrementer 22 as a new BN1. The new BN1 is written back to register 21 such that the read pointer 19 moves and points to the next track point. That is, the value of register 21 is updated such that the value of register-21 of the next cycle is added by 1. The read pointer 19 moves until the read pointer 19 points to a branch point. Updating of register 21 may also be controlled by the status of CPU 10. When the pipeline is stopped by CPU 10, register 21 is not updated.

When an instruction type contained in the contents of the track point indicates that the instruction is a conditional branch instruction, based on the TAKEN signal 20 indicating whether the branch is taken, selector 23 performs a selection operation. When the value of a BRANCH signal 40 is ‘1’, the value of register 21 is updated. That is, when CPU executes the branch source instruction, the TAKEN signal 20 is valid. At this time, if the value of TAKEN signal 20 is ‘1’ (it indicates that the branch is taken), selector 23 selects BN1 outputted by track table 13 to update register 21. That is, read pointer 19 points to the track point corresponding to the branch target instruction. If the value of TAKEN signal 20 is ‘0’ (it indicates that the branch is not taken), selector 23 selects BN1X from register 21 and BN1Y from incrementer 22 as a new BN1 to update register 21. That is, read pointer 19 points to the next track point.

When the read pointer of tracker 15 points to an entry of track table 13, the type of the branch source instruction is determined (a direct branch instruction or an indirect branch instruction).

In the present embodiment, the branch source instruction is a direct branch instruction. One L2 instruction block contains four L1 instruction blocks. The most significant two-bit of BN2Y is a sub-block number. One sub-block of every L2 instruction block equals to one L1 instruction block. That is, one sub-block number of every L2 instruction block corresponds to one L1 instruction block. For example, the sub-block number “00” corresponds to memory region 60; the sub-block number “01” corresponds to memory region 61; and so on.

When the read pointer 19 of tracker 15 points to an entry of track table 13, the value stored in the entry is read out via bus 30. If the value stored in the entry is a track address (i.e. BN2X and BN2Y) of L2 cache, BN2X and BN2Y are respectively used as a row address and a column address to search a corresponding entry in memory 902 via bus 30 and multiplexer 901, and check whether BN1X stored in the entry is valid such that it can be used to calculate a branch target instruction address of the branch source instruction in the future. If BN1X stored in the corresponding entry in memory 902 is valid (it indicates the corresponding branch target instruction is stored in L1 cache 16), BN1X stored in the corresponding entry in memory 902 is written into the entry of track table 13 pointed to the read pointer 19 of tracker 15 via bus 910 and multiplexer 911. At the same time, the value of BN2Y of the corresponding entry stored in track table 13 is updated by the value of the BN1Y (i.e. the sub-block number is removed from BN2Y).

Therefore, when CPU 10 executes the branch source instruction, based on the BN1 stored in the corresponding entry of track table 13, an instruction is read out directly from L1 cache 16 for CPU 10 to execute. If BN1X stored in the corresponding entry in memory 902 is invalid (it indicates the corresponding branch target instruction is not stored in L1 cache 16), based on BN2X and BN2Y of bus 30, L2 instruction sub-block containing the branch target instruction is filled to L1 cache 16 determined by BN1X generated by replacement logic from L2 cache 17. When CPU executes the instruction, the instruction may be read out directly from L1 cache 16 for CPU to execute. At the same time, the value of BN1X generated by replacement logic and the value of BN1Y (the sub-block number is removed from the BN2Y of bus 30) together are written into the entry of track table 13 pointed to by the read pointer 19 of tracker 15. The value of BN1X of the corresponding entry in memory 902 is set to valid.

At the same time, based on BN2X of bus 30, the corresponding tag stored in active list 91 is read out and is sent to a register of scanner 12 to calculate a branch target instruction address of the branch source instruction in the future. BN1X generated by replacement logic is stored in the register of scanner 12. Thus, when the obtained branch target address of the L2 instruction sub-block is written into the track table, BN1X is used as one row of track table 13 pointed to by the branch source address.

When the read pointer of tracker 15 points to an entry of track table 13, the value stored in the entry is read out via bus 30. When the branch source instruction is an indirect branch instruction, a branch target instruction address is calculated by CPU 10. Then, the branch target instruction address is sent to active list 91 via bus 908 and multiplexer 912 to perform a matching operation. If the matching operation is successful (it indicates the branch target instruction is stored in L2 cache 17), the successfully matched BN2X is sent to memory 902 via bus 903 and multiplexer 901 to search the corresponding row, and BN2Y of the branch target instruction obtained by calculation is sent to memory 902 via bus 905 and multiplexer 901 to search the corresponding column. If BN1X stored in the corresponding entry in memory 902 is valid, the operations are similar to the corresponding operations in the previous embodiments. The difference is that the instruction stored in L1 cache 16 is obtained immediately by the BN and the BN1Y of the calculated branch target instruction and sent to CPU 10. If BN1X stored in the corresponding entry in memory 902 is invalid, the operations are similar to the corresponding operations in the previous embodiments. The difference is that L2 instruction sub-block containing the branch target instruction stored in L2 cache 17 is filled immediately by BN2 value to L1 cache 16 determined by the replacement policy. At the same time, BN1X and the BN1Y of the branch target instruction obtained by calculation are written to the entry corresponding to the indirect branch instruction in track table 13 immediately, and the branch target instruction is sent to CPU 10 to execute.

If the matching operation is unsuccessful (it indicates the branch target instruction is not stored in L2 cache 17), the branch target address obtained by calculation is accessed from the lower level memory and filled to L2 cache determined by the replacement policy. The subsequent operations are similar to the corresponding operations in the previous embodiments.

In the following embodiments, every branch source instruction is a direct branch instruction.

When a L2 instruction sub-block in L2 cache 17 is filled to L1 cache 16, scanner 12 examines the L2 instruction sub-block which is sent from L2 cache 17 to L1 cache 16. When one instruction of the L2 instruction sub-block is a branch instruction, the branch target address of the branch source instruction is calculated.

To reduce power dissipation (that is, to reduce the times of accessing active list 91), the frequency of accessing active list 91 is reduced by judging whether the location of the branch target instruction is beyond L1 instruction block boundary, L2 instruction block boundary and the next level instruction block boundary of L2 instruction block.

When the scanner 12 calculates the branch target instruction address, the location of the branch target includes the following situations.

Situation 1: when the branch target address and the branch source address are in the same L1 instruction block (that is, the branch target instruction and the branch source instruction have the same BN1X), BN1X stored in the scanner and the BN1Y obtained by calculation are merged into a BN1. The BN1 is written into the entry of track table 13 pointed to via bus 922 by BN1X temporally stored in scanner 12 and BN1Y of the branch source instruction of scanner 12 via bus 907 and multiplexer 911. When the branch source instruction is executed, CPU 10 may directly read out the instruction from L1 cache 16 for CPU 10 to execute.

Situation 2: when the branch target address and the branch source address are in the same L2 instruction block (that is, the branch target instruction and the branch source instruction have the same BN2X), BN2X stored in the scanner and the BN2Y obtained by calculation are merged into a BN2. The BN2 is used to search the corresponding entry stored in memory 902 via bus 905 and multiplexer 901. If the value of BN1X stored in the corresponding entry of memory 902 is valid, the BN1X and the BN1Y (i.e. the sub-block number is removed from BN2Y obtained by calculation) are merged into BN1. The BN1 is written into the entry of track table 13 pointed to via bus 922 by BN1X temporally stored in scanner 12 and BN1Y of the branch source instruction of scanner 12 via bus 910 and multiplexer 911. When the branch source instruction is executed, CPU 10 may directly read out the instruction from L1 cache 16 for CPU 10 to execute. If the value of BN1X stored in the corresponding entry of memory 902 is invalid, BN2 is written into the entry of track table 13 pointed to via bus 922 by BN1X temporally stored in scanner 12 and BN1Y of the branch source instruction of scanner 12 via bus 910 and multiplexer 911. The subsequent operations are similar to the corresponding operations in the previous embodiments.

Situation 3: when the branch target address is in the previous L2 instruction block or the next L2 instruction block of the branch source address, BN2 is sent to memory 902 via bus 905 and multiplexer 901 to search BN2X of the previous L2 instruction block or the next L2 instruction block of the corresponding entry. The BN2X read out via bus 910 and the BN2Y obtained by calculation together point to another entry of memory 902. If the value of BN1X stored in the entry of memory 902 is valid, the BN1X and the BN1Y (i.e. the sub-block number is removed from BN2Y obtained by calculation) are merged into BN1. The BN1 is written into the entry of track table 13 pointed to via bus 922 by BN1X temporally stored in scanner 12 and BN1Y of the branch source instruction of scanner 12 via bus 910 and multiplexer 911. If the value of BN1X stored in the corresponding entry of memory 902 is invalid, BN2X corresponding to the entry and the branch target instruction BN2Y obtained by calculation are spliced together as a BN2. The BN2 is written into the entry of track table 13 pointed to via bus 922 by BN1X temporally stored in scanner 12 and BN1Y of the branch source instruction of scanner 12 via bus 910 and multiplexer 911. The subsequent operations are similar to the corresponding operations in the previous embodiments.

Situation 4: when the branch target address is beyond the previous L2 instruction block or the next L2 instruction block of the branch source address, the branch target instruction address obtained by calculation is sent to active list 91 via bus 907 and multiplexer 912 to perform a matching operation. If the matching operation is successful, the subsequent operations are similar to the corresponding operations in the previous embodiments. If the matching operation is unsuccessful, based on the branch target address obtained by calculation, the corresponding instruction block is fetched from the lower level memory and filled to L2 cache block determined by replacement policy, and the subsequent operations are similar to the corresponding operations in the previous embodiments.

As used herein, the instruction address is divided into 4 parts. FIG. 11 illustrates a schematic diagram of an exemplary instruction address and an exemplary branch distance consistent with the disclosed embodiments. As shown in FIG. 11, the low bits of an instruction address represents the location of the instruction in a L1 instruction block (i.e. the offset 50 of the instruction address), that is, the corresponding BN1Y. The middle segment of an instruction address represents the location of the L1 instruction block in a L2 instruction block (i.e. the sub-block number 51 of the instruction address). Therefore, the sub-block number 51 and the offset 50 together constitute BN2Y 54. Sub-block number 52 which is 1 bit high to sub-block number 51 is used to determine whether the branch target address is beyond the location of the next one or two level instruction block of the branch source address. The high bits 53 of the instruction address are used to match with the corresponding tag in the active list 91 to obtain match information. Three boundaries are generated at the connections of 4 parts of the instruction address. Accordingly, the branch target address is divided into three parts; where low bits 55 corresponds to BN1Y, middle segment 56 corresponds to sub-block number, and high bits 57 corresponds to high bits 53 of the instruction address.

The instruction target address is obtained by adding a branch source instruction address to a branch distance. During the addition process, an adder has three carry signals corresponding to the above three boundaries. If the branch distance is “0” in the above part of any one boundary and an adder carry of the boundary is “0”, it indicates that the branch target address is within the corresponding boundary; otherwise, it indicates that the branch target address is beyond the boundary. If the branch distance is “1” in the above part of any one boundary and an adder carry of the boundary is “1”, it indicates that the branch target address is within the corresponding boundary; otherwise, it indicates that the branch target address is beyond the boundary.

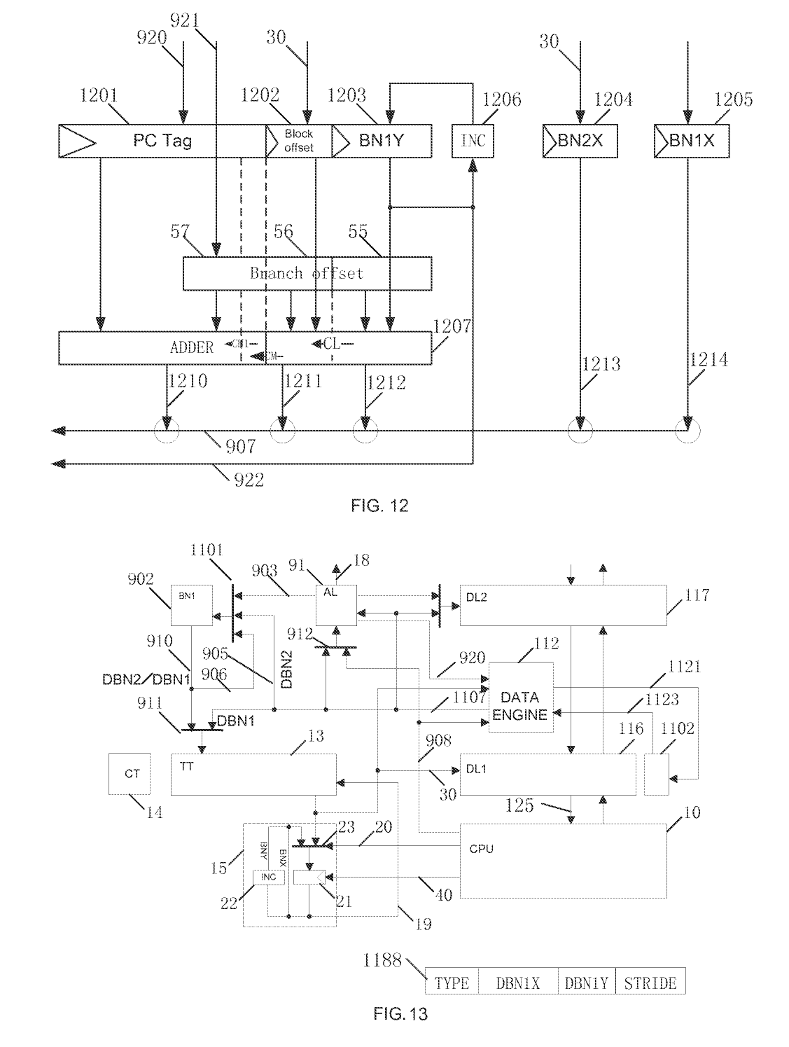

FIG. 12 illustrates a structure schematic diagram of an exemplary branch target address calculated by a scanner consistent with the disclosed embodiments. As shown in FIG. 12, the structure schematic diagram includes a first register 1201, a second register 1202, a third register 1203, a fourth register 1204, a fifth register 1205, an incrementer 1206, and an adder with multiple carry output 1207.

Bus 907 is used to send a branch target address to other modules of the cache system. Bus 907 also contains a control signal used to distinguish address format.

Branch source addresses (1201, 1202, 1203) are added to branch distances (57, 56, 55), and carry signals are extracted from three boundaries of the adder. Base on the above method, 3 non-overflow (within the boundary) signals are obtained. The 3 signals are processed by a priority selection logic so that the smallest valid, non-overflow signal is prevail and disabling the non-overflow signals corresponding to a larger boundary. This valid, non-overflow corresponding to the smallest boundary is put on bus 907 to indicate the address format.

Based on the above method, if it is determined that a branch target address is in a L1 instruction block containing a branch source instruction, BN1X stored in scanner 12 via bus 1214 and the BN1Y obtained by calculation via bus 1212 are spliced as a BN1. The BN1 via bus 907 is written into the entry of track table 13 pointed to via bus 922 by BN1X temporally stored in scanner 12 and BN1Y of the branch source instruction of scanner 12 via bus 907. When the branch source instruction is executed, CPU 10 may directly read out the instruction from L1 cache 16 for CPU 10 to execute.

If it is determines that the branch target instruction is in the L2 instruction block containing the current branch source instruction, bus 1213, bus 1211 and bus 1212 are spliced as a BN2 address. The BN2 address is sent to memory 902 via bus 907, and the subsequent operations are consistent with the above embodiment in FIG. 9.

If it is determined that the branch target instruction is in the next L2 instruction block of the L2 instruction block containing the current branch source instruction, bus 1213, bus 1211 and bus 1212 are spliced as a BN2 address. The BN2 address is sent to memory 902 via bus 907 to search information of the next L2 instruction block, and the subsequent operations are consistent with the above embodiment in FIG. 9.

If it is determined that the branch target instruction is beyond the next L2 instruction block of the L2 instruction block containing the current branch source instruction, bus 1210, bus 1211 and bus 1212 are spliced as a branch target address. The branch target address is sent to active list 91 via bus 907, and the subsequent operations are consistent with the above embodiment in FIG. 9. In addition, based on the sign bit of the branch distance, whether the branch target address is before or after the current branch source instruction may be determined.

The above technical solution can also be applied in the data cache. FIG. 13 illustrates a schematic diagram of an exemplary preparing data for data access instruction in advance consistent with the disclosed embodiments. The part related with data is shown in FIG. 13. The part related with instruction is omitted in FIG. 13.

A CPU 10, an active list 91, a correlation table 14, a tracker 15, a second multiplexer 912, and a memory 902 are the same as these units in FIG. 9. L1 cache and L2 cache are data cache, that is, L1 data cache 116 and L2 data cache 117. In addition, the role of data engine 112 for the data cache is equivalent to the role of the scanner 12 for the instruction cache, and a multiplexer with three-input 1101 replaces a first multiplexer with 4-input 901.

Cache blocks of L1 data cache 116 (i.e. L1 data block) are pointed to by DBN1X. Cache blocks of L2 data cache 117 (i.e. L2 data block) correspond to the entries of active list 91, and are pointed to by the same DBN2X.

Similarly to the embodiment of FIG. 9, L2 data cache 117 contains all data of L1 data cache 116. One L2 data cache block can correspond to a number of L1 data cache blocks. Specially, one L2 data cache block can correspond to four L1 data cache blocks in the present embodiment. A corresponding relationship between a DBN1X of a L1 data block and a DBN2X of a L2 data block is also stored in memory 902. Thus, according to DBN2Y, a corresponding DBN1X can be found from a row pointed to by the DBN2X in memory 902. The DBN1X and the lower part of DBN2Y (i.e. DBN1Y) together comprise DBN1, thus the DBN2 is translated into DBN1. In addition, the structure also contains a memory 1102. A row of memory 1102 corresponds to a L1 data block of L1 data cache 116, where every row stores a L2 data block number of the corresponding L1 cache block and a corresponding sub-block number of the BN1X in the BN2X, therefore DBN1X can be translated into DBN2X. The sub-block number and DBN1Y sent by bus 30 are merged into a DBN2Y.

Instruction type in the track points of track table 13 also includes a data access instruction (corresponding to a data point) in addition to the branch instruction (corresponding to a branch point). Similar to the branch point, data point format 1188 includes four parts: TYPE, a L1 data block number (DBN1X), a L1 block offset (DBN1Y) and a stride. The data access instruction type can also be further divided into a data access instruction and a data storage instruction. The stride is the difference of the corresponding data addresses when the CPU 10 continuously executes the same data access instruction twice.

Data engine 112 contains a stride calculation module. The stride calculation module is configured to perform a subtraction operation on the values of the corresponding data addresses when CPU 10 executes the same data access instruction twice. The obtained difference is the stride. Based on the stride, the possible prediction data address can be predicted when CPU 10 executes the same data access instruction again in the future.

In the embodiment, a L1 data block containing the prediction data address is filled in advance to L1 data cache 116. For a data access instruction, data corresponding to the prediction data address can further be read out and is placed on bus 125. When CPU 10 executes the data access instruction, L1 data cache 116 does not need to be accessed and the data is obtained directly from bus 125. For the data storage instruction, when CPU 10 executes the instruction, outputted data is temporally stored in a write buffer (not shown in FIG. 13) and written into the corresponding position when L1 data cache 116 is idle. For illustration purposes, the data access instruction is used as an example herein.

When the read pointer 19 of the tracker 15 points to the data point, based on the DBN1 in the contents of the data point (that is, DBN1X and DBN1Y) read out on bus 30, the corresponding data can be read out directly by addressing L1 data cache 116 and placed on bus 125 for the CPU 10 to execute. At the same time, the DBN1 and the stride on bus 30 are also sent to the data engine 112. Data engine 112 determines a location relationship of the prediction data address and the current data addresses by the similar prediction method on whether the branch target instruction is in the same L1/L2 instruction block in the above embodiment. Specifically, BN1Y corresponding to the data address is added with the stride together, and data engine 112 determines the location relationship based on whether the sum has a carry. It is assumed that a stride is a positive number herein. For other situations, referring to the embodiment in FIG. 9, the descriptions are not repeated herein.

Data engine 112 contains an adder, similarly to embodiment shown in FIG. 12. The adder is configured to calculate a sum of DBN1Y or DBN2Y and the corresponding part of the stride, and to determine whether the corresponding high bit segment of the stride is ‘0’, and whether the result of the adder is beyond a boundary. Specifically, if every bit of the high bit segment of the stride beyond DBN1Y is ‘0’ and the addition corresponding to DBN1Y has no carry output (it indicates that the prediction data address and the data address are located in the same L1 data block), at this time, DBN1X corresponding to the data address and DBN1Y calculated by the adder together constitute a DBN1. The DBN1 is filled back to the data point of track table 13 via bus 1107 and the first multiplexer 911 to replace the original content.

If the addition operation corresponding to DBN1Y has a carry output (it indicates that the prediction data address and the data address are located in the different data blocks of L1 cache), data engine 112 sends DBN1X of the data address to memory 1102 via bus 1121 to read out a corresponding DBN2X and a sub-block number. The corresponding DBN2X and the sub-block number are sent to data engine 112 via bus 1123. The sub-block number and DBN1Y sent by bus 30 together constitute a DBN2Y. The DBN2Y is added to the stride. If every bit of the high bit segment beyond the DBN2Y of the stride is ‘0’, and the addition corresponding to DBN2Y has no carry output (it indicates that the prediction data address and the data address are located in the same L2 data block), DBN2X corresponding to the data address sent by bus 1123 and DBN2Y calculated by the adder together constitute a DBN2. Data engine 112 places the DBN2 on bus 1107. The DBN2 is sent to memory 902 via multiplexer 1101 and is translated into DBN1. The DBN1 is filled back to the data point in track table 13 via bus 910 and the first multiplexer 911 to replace the original content.

If every bit of the high bit segment beyond the DBN1Y of the stride is ‘0’, and the addition corresponding to DBN2Y has a carry output but the higher bit has no carry output (it indicates that the prediction data address is located in the next one or two level data block of the L2 data block corresponding to the data address), data engine 112 places the DBN2X sent by bus 1123 on bus 1107. The DBN2X is sent to memory 902 via multiplexer 1101. A DBN2 of the next one or two level data block is read out by the above method. The DBN2 is sent back to memory 902 via bus 906 and the first multiplexer 911 and is translated into DBN1. The DBN1 is filled back to the data point in track table 13 via bus 910 and the first multiplexer 911 to replace the original content.

If the higher bit of the addition corresponding to DBN2Y also has a carry output (it indicates that the prediction data address is located outside the next one or two level data block of the L2 data block corresponding to the data address), data engine 112 sends the DBN2X corresponding to the data address sent by bus 1123 to active list 91 via bus 1107 to read out a L2 data block address. The DBN2X is sent back to data engine 112 via bus 920. The DBN2X and DBN2Y that contains the sub-block number sent by bus 1123 and the DBN1Y sent by bus 30 together constitute a data address at this time. Then, a prediction data address is obtained by adding the data address to the stride. The prediction data address is sent back to active list 91 via bus 1107 and a second multiplexer 912 to perform a matching operation. If the matching operation is successful, the DBN2X corresponding to successfully matching result is obtained. The subsequent instructions are similar to the corresponding operations in the above embodiment. In the end, the DBN1 is filled back to the data point in track table 13 to replace the original content. If the matching operation is unsuccessful, the prediction data address is outputted via bus 18 to a lower level memory to obtain the corresponding data block. The subsequent instructions are similar to the corresponding operations in the above embodiment. In the end, the DBN1 is filled back to the data point in track table 13 to replace the original content.

Thus, when the read pointer 19 of the tracker 15 points to the data point again, the contents of the data point read out on bus 30 contains DBN1. Based on the DBN1, the corresponding data is read out by directly addressing L1 data cache and placed on bus 125 for the CPU 10 to execute. When CPU 10 executes the data access instruction and generates a data address, the data address is sent to data engine 112 via bus 908 to compare with the prediction data address. If the comparison result is equal, CPU 10 directly reads out the data prepared in advance. If the comparison result is not equal (it indicates that the prediction data address is wrong), at this time, the data address is sent to active list 91 via bus 908 to perform a matching operation. The subsequent instructions are similar to the corresponding operations in the above embodiment. In the end, the correct data is provided for CPU 10 to execute.

The above process is repeated. Before CPU 10 executes the data access instruction, a data address is predicted. The corresponding data is pre-filled to a L1 data cache 116, thereby reducing the data cache misses. When CPU 10 executes the data access instruction again, the corresponding data has been placed on bus 125, thereby further reducing the access time of data cache hits.

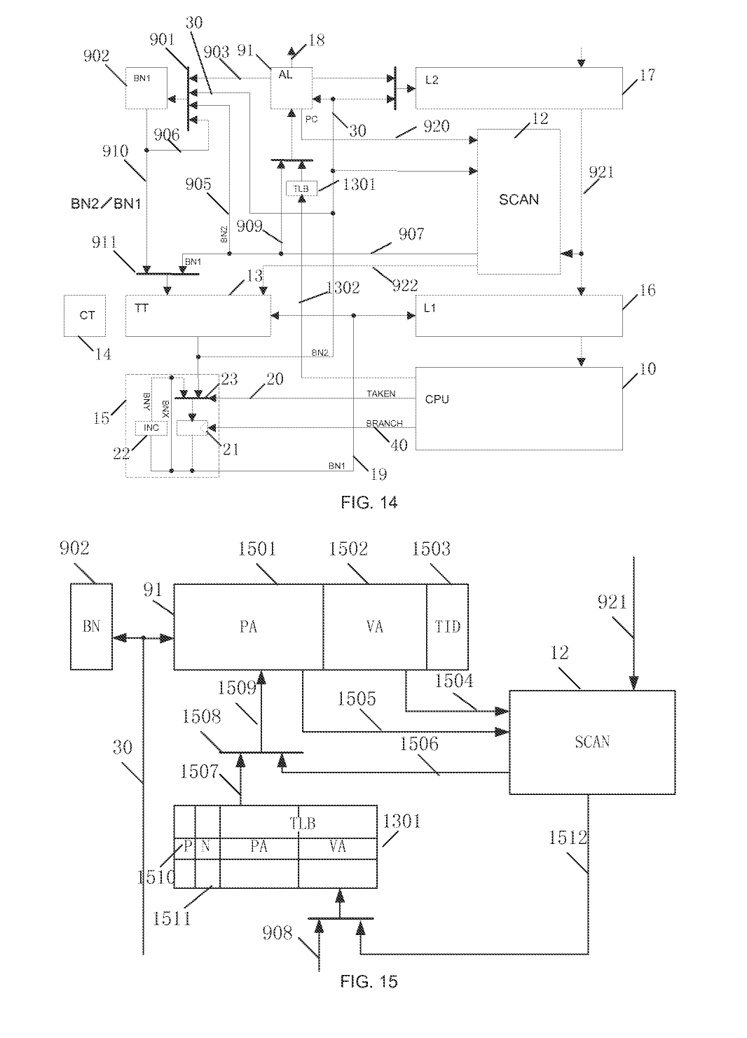

FIG. 14 illustrates a structure schematic diagram of an exemplary translation lookaside buffer (TLB) between a CPU and an active list consistent with the disclosed embodiments. As shown in FIG. 14, the structure includes a CPU 10, an active list 91, a scanner 12, a track table 13, a correlation table 14, a tracker 15, a level one cache 16 (i.e., a first level memory, that is, a memory with the fastest access speed), and a level two cache 17 (i.e., a second level memory, that is, a memory with the lowest access speed), a multiplexer 911, a memory 902, and a TLB 1301.

TLB 1301 is located between CPU 10 and active list 91. Therefore, a L2 instruction block address stored in active list 91 is a physical address. The addressing addresses of L2 cache 17 and L1 cache 16 are all physical addresses. The address calculated by CPU 10 is a virtual address. The virtual address is translated into the physical address by TLB 1301.

When the read pointer 19 of the tracker 15 points to an entry of track table 13, the contents of the entry are read out from bus 30. If the instruction is an indirect branch instruction and instruction format is BN2, tracker 15 stays on the entry and waits for CPU 10 to calculate a branch target address. A BRANCH-signal 20 is sent by CPU 10 to notify the system that the address on bus 908 is a valid virtual branch target address. After the address is sent to TLB 1301 to map to a corresponding physical address, the corresponding physical address is sent to active list 18. After active list 18 maps the address to a corresponding BN2, BN2 is sent to memory 902 via bus 903 and multiplexer 901 to match with a corresponding BN1. If the BN1 is invalid, the corresponding sub cache block of L2 cache is fetched in L2 cache 17 by a block address BN2X of the BN2 and filled to L1 cache. The block number BN1 of the L1 cache block being filled is correspondingly filled to memory 902.

If the physical address is not matched in active list 18, an instruction block that is read from the lower level memory by using the physical address is filled to a L2 cache block pointed to by L2 replacement logic, and filled to a L1 cache block pointed to by L1 replacement logic. At the same time, BN1 is filled into a L1 block number region pointed to by a sub-block number (that is, the high bit segment equivalent to BN2Y in the physical address) of L2 cache of the entry pointed to by BN2X in memory 902. If the above virtual address is not matched in TLB 1301, a TLB miss signal is generated to request an operating system to handle.

A BN1X pointed to by the BN2 and the low bit BN1Y of the physical address are spliced as a BN1 in memory 902. The BN1 is stored in the entry (the entry originally stores the table entry of an indirect branch target BN2 address) pointed to by read pointer 19 in track table 13. The table entry is read out via bus 30 and is determined that the format is BN1. If the branch type is an unconditional branch, or the branch type is a conditional branch and BRANCH signal 40 outputted by CPU 10 is ‘taking a branch’, the BN1 is stored in register 21 and placed on bus 19 to control L1 cache 16 to read out the corresponding branch target instruction for CPU 10 to execute. If the branch type is a conditional branch but BRANCH signal 40 outputted by CPU 10 is ‘non-branch’, the output of incrementer 22 is stored in register 21 and placed on bus 19 to control L1 cache 16 to read out the next instruction of the branch source instruction in order for CPU 10 to execute.

When the same indirect branch instruction is executed next time, instruction type on bus 30 is an indirect branch instruction, but address format is BN1. At this time, if the branch is taken based on branch type or branch judgment of CPU 10, the BN1 is placed on bus 19 to control L1 cache 16 to read out the corresponding branch target instruction for CPU 10 to execute speculatively. Then, based on the instruction type of the branch target instruction, the instruction continues to be executed speculatively. The accurate BN1 generated by the branch target virtual address generated by CPU 10 in the mapping process is compared with the speculative BN1 read out from the track table. If the comparison result is the same, the instruction continues to be executed; if the comparison result is not same, the speculative execution results or intermediate results executed by CPU 10 are cleared. The accurate BN1 obtained by the mapping process is stored in the branch source entry, and the tracker starts to execute an instruction from the accurate BN1 stored in the branch source entry.

When the read pointer 19 of the tracker 15 points to an entry of track table 13, the contents of the entry are read out from bus 30. If the instruction is a direct branch instruction (it indicates that the branch target instruction address BN2 or BN1 is a correct address), the subsequent operations are similar to the corresponding operations in the previous embodiments.

When a L2 cache sub-block is filled to L1 cache, the instructions in the L2 cache sub-block are examined by scanner 12 to extract information to fill to the track in track table 13 corresponding to the L1 cache block. The branch target of the branch instruction is calculated by scanner 12. Because the block address read out from active list 91 is a physical address, when scanner 12 calculates a branch target address, scanner 12 needs to determine whether the address is beyond the TLB page (branch target and branch source are not on the same page). The address can be classified into an outside page part of the high bit and an Interior page part of low bit based on the page size. When the branch target instruction is calculated, based on whether all bits of a branch offset outside the page is ‘0’ or ‘1’ and a carry of an adder of the page boundary, the corresponding operations are performed to judge whether the branch target is beyond the page. When the branch target and the branch source are in the same page, the operations are the same as the operations in the embodiment in FIG. 9, which is not repeated herein. If the branch target address is beyond the page, PC address sent by scanner 12 via bus 907 might be wrong because the page numbers of the physical addresses are not always consecutive. So a mechanism that can prevent errors is needed when the branch target is beyond the page. The following methods can prevent the above described error.

The first method may refer to FIG. 14. When scanner 12 calculates a branch target of a direct branch instruction and finds the branch target is beyond the page, scanner 12 translates the type of the branch instruction into an indirect branch instruction and sets address format to BN2. The translated branch instruction is written directly to the corresponding entry of the direct branch instruction in track table 13, instead of finding memory 902 to translate the address into the BN1. When the table entry is read out from bus 30, the instruction is treated as an indirect branch instruction. The branch address is calculated by CPU 10. The obtained virtual address is mapped to a physical address in TLB 1301. In the end, the address is mapped to a BN1 in memory 902. The BN1 is written back to the table entry in track table 13. The subsequent operations are similar to the corresponding operations in the previous embodiments. That is, based on the BN1 address in the table entry, the branch is speculatively executed and verified by the accurate branch target address generated by CPU 10.

Further, a new instruction type is defined to represent the situation that a direct branch instruction in the corresponding table entry of track table 13 is marked as an indirect branch, known as Direct-Marked-As-Indirect (DMAI). When DMAI BN2 is read out from bus 30, the branch is speculatively executed and verified by the accurate branch target address generated by CPU 10. Then, after the branch target address is translated into BN1 type, when DMAI BN1 is read out from bus 30, the system does not perform an address verification operation, instead, the table entry is considered as a direct branch type to execute.

The second method may refer to FIG. 15. An extra virtual address corresponding to a physical address and a thread number (TID) are added in every table entry of active list 18. FIG. 15 illustrates a structure schematic diagram of another exemplary virtual address to physical address translation consistent with the disclosed embodiments. As shown in FIG. 15, active list 91 includes a memory block 1501 configured to store physical address (PA), a memory block 1502 configured to store virtual address (VA), and a memory block 1503 configured to store thread number (TID). TLB 1301 is configured to store physical address (PA) and virtual address (VA). Further, TLB 1301 also contains a memory block 1510 configured to store an index address of a previous page number of PA in TLB, and a memory block 1511 configured to store an index address of a next page number of PA in TLB. Other required structure is the same as the structure shown in FIG. 14. In addition, the previous similar method is used to determine whether the branch target address is within the current page.

When an addressing operation for active list 91 is performed via BN2X on bus 30, PA and VA stored in memory block 1501 and memory block 1502 are read out and sent to scanner 12 via bus 1505 and bus 1504, respectively. Thus, scanner 12 may not only directly calculate a branch target physical addresses, but also calculate a branch target virtual address based on the virtual address. When the branch target address calculated by scanner 12 is within the current page, the branch target address obtained by calculation is sent to memory block 1501 of active list 91 to perform a matching operation via bus 1506, multiplexer 1508 and bus 1509. The subsequent operations are consistent with the above embodiments.

When the branch target address calculated by scanner 12 is within an adjacent page of the current page, the branch target address obtained by calculation is sent to memory block 1501 of active list 91 to perform a matching operation via bus 1506, multiplexer 1508 and bus 1509. The address type is marked as within the next or the previous page by the method shown in FIG. 12. The matched memory block 1510 or memory block 1511 in table entry is read out. Then, according to the value of memory block 1510 or memory block 1511, a corresponding row in TLB 1301 is found. The subsequent operations are consistent with the above embodiments.

When the branch target address calculated by scanner 12 is not within the current page, the branch target virtual address obtained by calculation is sent to TLB 1301 to perform a matching operation via bus 1512. If the matching operation is successful, the corresponding branch target physical address is sent to active list 91 to perform a matching operation via bus 1507, multiplexer 1508 and bus 1509, and the subsequent operations are consistent with the above embodiments. If the matching operation in TLB 1301 or memory block 1501 is unsuccessful, the subsequent operations are consistent with the above embodiments.

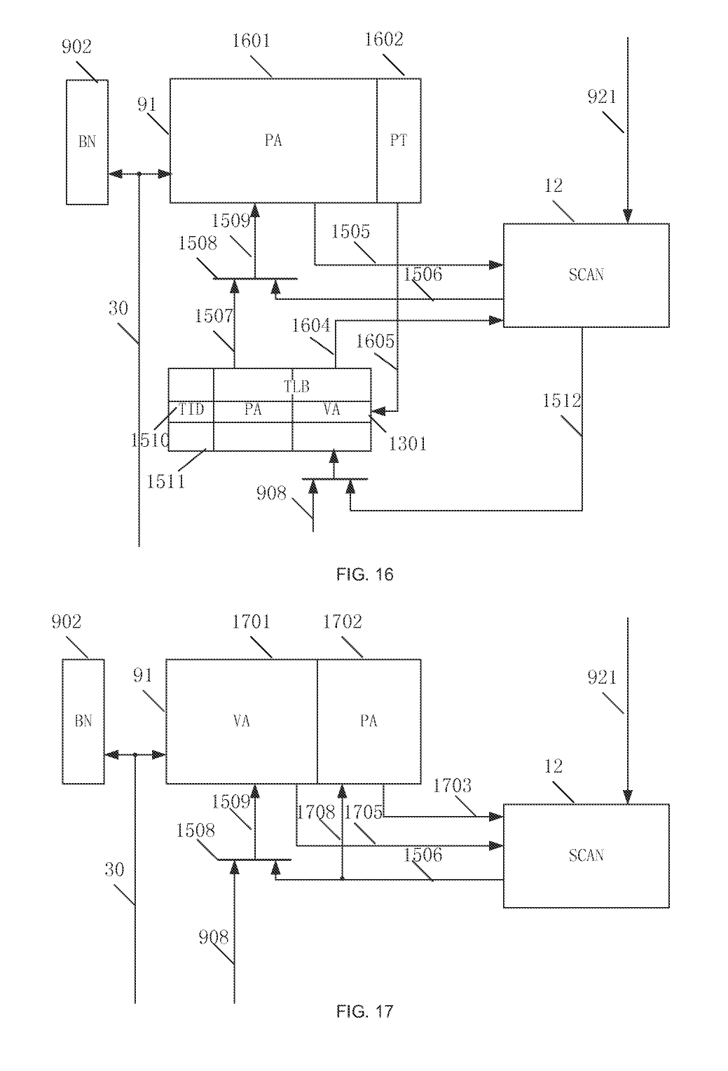

The third method may refer to FIG. 16. FIG. 16 illustrates another structure schematic diagram of an exemplary virtual address to physical address translation consistent with the disclosed embodiments. As shown in FIG. 16, active list 91 includes a memory block 1601 configured to store physical address (PA), and a memory block 1602 configured to store a pointer (PT) that points to the corresponding row in TLB. A memory block which stores virtual address (VA) is not included in FIG. 16. Other required structure is the same as the structure shown in FIG. 15.

When BN2X of bus 30 performs an addressing operation to active list 91, the corresponding physical address stored in memory block 1601 is sent to scanner 12 via bus 1505. When the branch target address obtained by calculation is within the current page, the subsequent operations are consistent with the above embodiments. When the branch target address obtained by calculation is beyond the current page, based on the BN2X value of bus 30, a corresponding row of TLB 1301 pointed to by a pointer stored in memory block 1602 via bus 1605 is read out, and a virtual address of the corresponding row stored in TLB 1301 is read out and sent to scanner 12 via bus 1604 to calculate a branch target address. The obtained branch target virtual address is sent to TLB 1301 via bus 1512, and the subsequent operations are consistent with the above embodiments.

The fourth method may refer to FIG. 17. FIG. 17 illustrates another structure schematic diagram of calculating a branch target address consistent with the disclosed embodiments. As shown in FIG. 17, active list 91 includes a memory block 1701 configured to store virtual address (VA) and a memory block 1702 configured to store virtual address (VA). The memory block 1701 is also configured to store a virtual address and the corresponding thread number (TID). The structure of memory block 1702 can be any one of a direct-mapped memory, a set associative memory and a fully associative memory. The TLB is no longer required in FIG. 17, and the virtual address to physical address translation is completed in active list 91.

When BN2X of bus 30 performs an addressing operation to active list 91, a virtual address and a physical address stored in memory block 1701 and memory block 1702 are read out and sent to scanner 12 to calculate a branch target virtual address and a branch target physical address via bus 1705 and bus 1703, respectively.

When the branch target physical address is within the current page, the branch target physical address obtained by calculation is sent to memory block 1702 via bus 1708 to perform a matching operation, and the subsequent operations are consistent with the above embodiments. When the branch target physical address is beyond the current page, the branch target virtual address is sent to memory block 1701 via bus 1506, multiplexer 1508 and bus 1509 to perform a matching operation. If the matching operation in memory block 1701 or memory block 1702 is unsuccessful, the process is similar to the above embodiments. Thus, the corresponding branch target BN2 may be obtained, and the subsequent operations are consistent with the above embodiments.

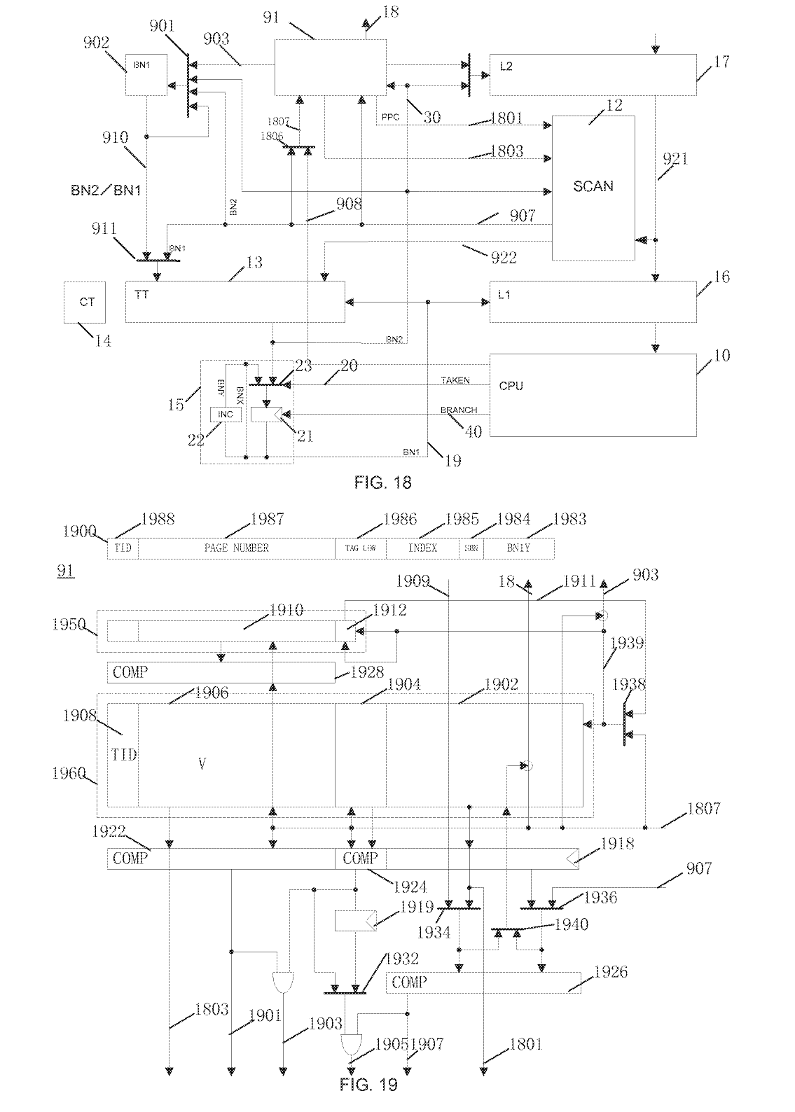

The fifth method may refer to FIG. 18. FIG. 18 illustrates another structure schematic diagram of an exemplary virtual address to physical address translation consistent with the disclosed embodiments. The structure schematic diagram is similar to the structure schematic diagram in FIG. 9. The difference is that every table entry in active list 91 stores a tag part of a virtual address and a physical address corresponding to L2 instruction block of L2 instruction cache 17, and every table entry has a valid bit. The stored virtual address also contains a thread number (TID). The structure of active list 91 can be any one of a direct-mapped active list, a set associative active list and a fully associative active list. In addition, a physical page number of active list 91 is sent to the scanner 12 via bus 1801 to calculate the branch target address. A virtual page number of active list 91 and the low bit of the tag part are sent to scanner 12 via bus 1803 to calculate the branch target address. The physical page number obtained by the matching operation of active list 91 is sent directly by scanner 12 via bus 907. The virtual address is sent via bus 1807. Bus 1807 has two sources: bus 907 of scanner 12, and bus 908 of CPU 10.

The role of active list 91 is the same as the role of the tag unit and TLB in the traditional cache system. FIG. 19 illustrates a schematic diagram of an exemplary address format 1900 consistent with the disclosed embodiments. As used herein, active list 91 is a direct-mapped active list. The address format of a set associative active list and a fully associative active list are similar to the address format of the direct-mapped active list. Address format 1900 from high bit to low bit (from left to right) is divided into a number of segments, where segment 1988 is a thread number; segment 1987 is page number (a virtual address page number or a physical address page number); segment 1986 is low bit of a tag; segment 1987 and segment 1986 are spliced as an address tag; segment 1985 is an index bit; segment 1984 is a L2 cache sub-block number (i.e. high bit segment of BN2Y); and segment 1983 is an offset BN1Y in L1 cache block. Segment 1986, segment 1985, segment 1984, and a L1 cache block offset BN1Y are the same no matter it is a virtual address or a physical address. Thread number 1988 is used to distinguish the same virtual address of different threads when a virtual address addressing operation is performed.

Active list 91 includes active list memory 1960. The active list memory 1960 is constituted by a plurality of table entries. The table entries correspond to cache blocks stored in L2 cache one by one. The reading of the table entry is addressed by bus 1939 (BN2X address format) and the writing of the table entry is addressed by level 2 cache replacement algorithm (such as LRU). In every entry, segment 1908 is a thread number of a virtual address; segment 1906 is a page number of the virtual address; segment 1902 is a page number of a physical address; and segment 1904 is a low bit part of the tag which is a common tag part of the virtual address and the physical address. Segment 1908, segment 1906 and segment 1904 together constitute a virtual address label by splicing. Segment 1902 and segment 1904 together constitute a physical address label by splicing.

A virtual address to be compared with the contents of active list 91 is placed on bus 1807. A physical page number to be compared with the contents of active list 91 is placed on bus 907. The address on bus 1807 contains a thread number 1988, a virtual page number 1987, a low bit of the tag 1986 and an index bit 1985, where the index bit is used to perform an addressing operation to the entry of active list 91 in direct-mapped way or set associative way. The index bit is also used to compare with the contents of memory 1960 in a fully associative way. Because the contents on bus 1807 are from bus 907, so bus 907 contains all segments of the address, including a virtual page number, a physical page number, and sub-block number 1984 of L2 cache and BN1Y 1983.

In addition, active list 91 also contains an anti-aliasing table 1950. The anti-aliasing table 1950 is constituted by a plurality of table entries. Each table entry contains a memory thread number and a virtual page number segment 1910 and a segment 1912 containing value of BNX2.

The BNX2 is a L2 cache block number in the virtual page stored in L2 cache 17. The load address of anti-aliasing table 1950 is provided by bus 1939. The store address of anti-aliasing table 1950 is provided by customized replacement logic based on replacement algorithms (e.g., LRU).

The function of anti-aliasing table differs from the function of the conventional TLB. The anti-aliasing table only stores the second occurrence of the virtual page number and the next virtual page number when the corresponding same physical page number runs. In addition, the anti-aliasing table also includes comparators 1922, 1924, 1926 and 1928; registers 1918 and 1919; and multiplexers 1932, 1934, 1936, 1938 and 1940. The multiplexer 1932 selects output of comparator 1924 and the output after the output of comparator 1924 is stored by register 1919. Multiplexer 1934 selects segment 1902 of physical page number in active list 1960 and an output of bus 1909. Multiplexer 1936 selects an output of register 1918 and an input of bus 907. Multiplexer 1938 selects index bit 1985 from bus 1807 and index bit stored in segment 1912 in the anti-aliasing table to generate bus 1939. Multiplexer 1940 selects an output of register 1918 or an input of bus 1909 to place the selected result on bus 18.

An addressing operation is performed by index bit 1985 on bus 1807 to read out a table entry corresponding to an index bit address from memory 1960 of track table 91. Segments 1908, 1906, 1904, and 1902 are sent respectively to comparators 1922, 1924, 1926, and compared with other segments of bus 1807 and a physical page number on bus 907.

Comparator 1922 is configured to compare a thread number and a virtual address page number read out from segments 1908 and 1906 with thread number 1988 and virtual address page number 1987 sent from bus 1807. The comparison result is sent out as signal 1901. If the comparison result is the same, it indicates the virtual address of TLB hits.

Comparer 1924 is configured to compare the low bit part of the tag read out from segment 1904 with the low bit part 1986 of the tag of a virtual address sent from bus 1807. After the comparison result and register 1911 perform a ‘AND’ operation, the operation result is sent by signal 1903. If the result is ‘1’, it indicates the virtual address of cache hits.

Similarly, the comparator 1926 is configured to compare a physical page number read out from segment 1902 and selected by multiplexer 1934 with page number part 1987 of a physical address sent from bus 907 and selected by multiplexer 1936. The comparison result is sent out from signal 1907. If the comparison result is the same, it indicates the physical address of TLB hits. Because the tag of the virtual address and the low bit 1986 of the tag of the physical address are the same, the comparison result of comparator 1924 selected by multiplexer 1932 and signal 1907 perform a ‘AND’ operation. The operation result is sent out from signal 1905. If the result is ‘1’, it indicates the physical address of cache hits.

Referring to FIG. 18 and FIG. 19, the operation of the embodiment is illustrated. When one L2 cache sub-block is filled to a L1 cache, instructions in the block are examined by scanner 12. The type of the examined instruction is filled into a table entry corresponding to the instruction in track table 13. If the examined instruction is a branch instruction, scanner 12 calculates the branch target address. If the branch target instruction and the branch source instruction are within the adjacent L2 cache block, the branch target address is calculated according to the previous embodiment. If the branch target is beyond the boundary, scanner 12 sends the physical address or the virtual address to the active list 91 via bus 907 to perform a matching operation to generate a corresponding BN2 address. The corresponding BN2 address is sent to memory 902 to perform matching operation and obtain BN1. The BN1 is stored in track table 13.

In addition, based on internal storage status of active list 91, and the input from bus 907 and bus 1807, active list 91 decides the operations for L2 cache and the active list itself. Bus 907 outputted by scanner 12 can simultaneously provide a virtual address and the page number of a physical address for comparing. The page number of the physical address is sent directly to track table 91 to perform a matching operation with the page number of the physical address in track table 91. After the virtual address part is selected by multiplexer 1806, the selected result is sent to the track table via bus 1807 to perform a matching operation with a virtual address in track table 91. Another input of multiplexer 1806 is a branch target virtual address sent from CPU 10 via bus 908.

First, scanner 12 determines whether the address is beyond the page. The judgment method may refer to the previous embodiment. If the address is not beyond the page, scanner 12 places physical address block number 1987, low bit 1986 of a tag, index bit 1985 on bus 907 and sends them to active list 91 to perform a matching operation. In addition, L2 cache sub-block number 1984 and L1 cache block offset 1983 are also placed on bus 907 and placed on bus 1807 via multiplexer 1806 for CPU to execute in the future. Index bit 1985 (BNX2) is selected by multiplexer 1938 and placed on bus 1939. BN2X on bus 1939 is used as an address to read out a table entry from memory 1960 to match with the address on bus 907 and bus 1807.

Physical page number 1987 on bus 907 selected by multiplexer 1936 and a physical page number of segment 1902 of table entry selected by multiplexer 1934 are compared in comparator 1926. The comparison result is 1907. After the low bit 1986 of the tag of bus 1807 is selected by multiplexer 1806, the selected result that is placed on bus 1807 and the low bit of segment 1904 of table entry are compared in comparator 1924. The comparison result selected by multiplexer 1932 and result 1907 are performed a ‘AND’ operation. When the ‘AND’ operation result 1905 is ‘1’ (it indicates that the branch target instruction is stored in L2 cache 17), at this time, index bit (i.e. BN2X) on bus 1939 and L2 cache sub-block 1984 on bus 1807 are spliced and send to memory 902 via bus 903 and multiplexer 901 to map a corresponding BN1X. The obtained BN1X and BN1Y 1983 on bus 907 together are written to an entry corresponding to the branch source instruction in track table 13.

If memory 902 has no corresponding BN1X, BN2X and BN2Y (1984, 1983) on bus 1807 are spliced as a BN2. The BN2 is written to a table entry corresponding to the branch source in track table 13. The entry of track table 13 is pointed to by BN1X that is being written to a L1 cache block of L1 cache temporally stored in scanner 12 and the BN1Y corresponding to the branch source via bus 922. This scenario is called as scenario 1.

When matching result 1905 is ‘0’ and matching result 1907 is ‘1’, it indicates that the branch target instruction has not yet been stored in L2 cache 17, but the physical page number of TLB hits. That is, the physical page number is known. At this time, the physical page number on bus 907 selected by multiplexer 1936 and multiplexer 1940, index bit 1985 and low bit 1986 of the tag on bus 1807 together are spliced as a physical address. After the spliced physical address is sent to a low level memory to read the corresponding instruction block, the instruction block is stored in a L2 cache block in L2 cache 17 specified by L2 cache replacement logic. A BN2 is generated by a L2 cache block number BN2X and is written into the table entry corresponding to the branch source instruction in track table 13. At this time, the address on bus 907 and bus 1807 is written into the corresponding segment of in active list memory 160 pointed to by the BN2X. This scenario is called as scenario 2.

If scanner 12 determines that the branch target address is beyond the page, scanner 12 places thread number 1988, virtual address block number 1987, low bit of the tag 1986 and index bit 1985 on bus 907. Thread number 1988, virtual address block number 1987, low bit of the tag 1986 and index bit 1985 on bus 907 are selected by multiplexer 1806 and are sent to active list 91 to match via bus 1807. In addition, L2 cache sub-block number 1984 and L1 cache block offsets 1983 are also placed on bus 907 and are selected by multiplexer 1806. The selected result is place on bus 1807 for CPU 10 to use in the future. When matching result 1903 is ‘1’, it indicates that the branch target instruction is stored in L2 cache 17. BN2X on bus 1939 and L2 cache sub-block number 1984 on bus 1807 are mapped to the corresponding BN1X in memory 902. BN1 or BN2 (the mapping is invalid) is stored in the table entry of track table 13. This scenario is called as scenario 3.

When matching result 1903 is ‘0’ and matching result 1901 is ‘1’, it indicates that the branch target instruction has not yet been stored in L2 cache 17, but the virtual page number of TLB hits. That is, the virtual page number is known. The physical page number segment 1902 of the hit table entry stores a correct physical page number. At this time, physical page number segment 1902 of the hit table entry selected by multiplexer 1934 and multiplexer 1940, index bit 1985 and low bit 1986 of the tag on bus 1807 together are spliced as a physical address. After the spliced physical address is sent to a low level memory via bus 18 to read a corresponding instruction block, the instruction block is stored in a L2 cache block in L2 cache 17 specified by L2 cache replacement logic. A BN2 is generated by a L2 cache block number BN2X and is written into the table entry corresponding to the branch source instruction in track table 13. At this time, the address on bus 907 and bus 1807 is written into the corresponding segment of active list memory 160 pointed to by the BN2X. This scenario is called as scenario 4.

When matching result 1903 is ‘0’ and matching result 1901 is ‘0’, it indicates that the branch target instruction has not yet been stored in L2 cache 17, and active list memory 1960 does not have a corresponding virtual page number. At this time, a comparison result of comparator 1924 (comparing to low bit of the tag) is temporally stored in register 1919, and a physical page number in the table entry read out on bus 18 is temporally stored in register 1918 for CPU 10 to use in the future. The corresponding table entry is read out via bus 1939 in anti-aliasing table 1950. The thread number and virtual page number segment 1910 of table entry are compared with thread number 1988 and virtual page number 1987 on bus 1807 by comparator 1928. If the comparison result is hit, segment 1912 of L2 cache block number (BN2X) in the table entry via bus 1911 is sent to multiplexer 1938 and is selected as a new index value 1939 pointing to active list memory 1960. By the new index value, physical page number segment 1902 read out from a table entry of active list memory 1960 selected by multiplexer 1934 is compared with the physical page number that is selected by multiplexer 1936 and temporally stored in register 1918. The comparison result 1907 and the comparison result that is selected by multiplexer 1932 and temporally stored in register 1919 perform a ‘AND’ operation. If the result 1905 is ‘1’, it indicates that the virtual page number read out from anti-aliasing table 1950 has a corresponding physical page number stored in active list memory 1960. Because low bit 1904 of the tag in the same table entry of the physical page number and low bit 1986 of the tag in the address to be matched are the same, it indicates the instruction block is in L2 cache. At this point, BN2X on bus 1939 is sent to memory 902 via bus 903 to match with BN1X and then sent to the track table 13 for storing, thus avoiding aliasing and cache pollution. This scenario is called as scenario 5.

When comparison result 1905 is ‘0’, it indicates that the instruction block containing the instruction corresponding to the branch target virtual address sent from bus 1807 has not yet been stored in L2 cache 17. It is called cache miss. This scenario is called as scenario 6. At this time, physical page number that is selected by multiplexer 1936 and multiplexer 1940 and temporally stored in register 1918, index bit 1985 and low bit 1986 of the tag on bus 1807 together are spliced as a physical address. After the spliced physical address is sent to a low level memory to read a corresponding instruction block, the instruction block is stored in a L2 cache block in L2 cache 17 specified by L2 cache replacement logic.

At the same time, thread number 1988, virtual page number 1987, and low bit 1986 of the tag on bus 1807, and the physical page number that are selected by multiplexer 1934 and multiplexer 1940 and temporally stored in register 1918 are written to segments 1908, 1906, 1904 and 1902 of the table entry corresponding to the L2 memory block in active list memory 1960, respectively. At the same time, the L2 memory block address BN2X is placed on bus 903 and is sent to memory 902 to match with BN1X. The result (BN1 or BN2) is sent to track table 13 and stored in track table 13.

Or the content of the anti-aliasing table is compared with a virtual page number on bus 1807 in comparator 1928. If the comparison result is a miss, it indicates that no physical page number corresponding to the virtual page number on bus 1807 is stored in the active list memory 1960. It is equivalent to TLB miss of the traditional cache system. This scenario is called as scenario 7. At this time, CPU generates a TLB miss exception. The operating system handles the exception based on current technology. The operating system searches a physical page number corresponding to a virtual address on bus 1807 and performs a TLB filling operation. The physical page number from bus 1909 is sent to active list 91 and selected by multiplexer 1934. The selected result is compared with a physical page number that is selected by multiplexer 1936 and temporally stored in register 1918. The comparison result 1907 and a comparison result (comparing to low bit of the tag) that is selected by multiplexer 1932 and temporally stored in register 1919 performs a ‘AND’ operation to generate a comparison result 1905. If the result is ‘1’, it indicates a plurality of thread numbers and virtual page numbers are mapped to the same physical page number (i.e. aliasing scenario). It is called scenario 7. At this time, thread number 1988 and virtual page number 1987 on bus 1807 are written to segment 1910 of the table entry specified by replacement logic in anti-aliasing table 1950. Index segment BNX2 on bus 1807 selected by multiplexer 1938 is written to segment 1912 in anti-aliasing table 1950 via bus 1939. At the same time, index segment 1985 (BNX2) on bus 1939 and L2 cache sub-block number 1984 on bus 1807 together are spliced and sent to memory 902 via bus 903. Referring to the previous embodiment, after matching with BN1X, the result is written to the track table 13.

When the comparison result 1905 is ‘0’, it indicates that there is no aliasing, but the instruction block containing the instruction corresponding to the branch target virtual address sent from bus 1807 has not yet been stored in L2 cache 17. It is similar to cache miss. This scenario is called as scenario 8. At this time, a physical page number selected by multiplexer 1934 and multiplexer 1940 from bus 1909, index bit 1985 and low bit 1986 of the tag on bus 1807 together are spliced as a physical address. After the spliced physical address is sent to a low level memory to read a corresponding instruction block, the instruction block is filled in a L2 cache block in L2 cache 17 specified by L2 cache replacement logic. At the same time, thread number 1988, virtual page number 1987, and low bit 1986 of the tag on bus 1807, and the physical page number selected by multiplexer 1934 and multiplexer 1940 on bus 1919 are written to segments 1908, 1906, 1904 and 1902 of the table entry corresponding to the L2 memory block in active list memory 1960, respectively. At the same time, after the L2 memory block address BN2X and L2 cache sub-block number 1984 on bus 1807 are spliced, the spliced result is placed on bus 903 and is sent to memory 902 to match with BN1X. The result is sent to track table 13 and stored in track table 13.

The above 8 scenarios refer to the scenarios for scanner 12 to scan instructions filled into L1 cache to generate a branch target address when the branch target address and branch source are not in the adjacent L2 cache blocks. The scenarios 1-2 are physical address matching scenarios, and the scenarios 3-8 are virtual address matching scenarios.

The read pointer 19 of tracker 15 controls a read port of track table 13 to read out the contents of one table entry on bus 30. When the table entry is an indirect branch type, read pointer 19 stays at the table entry to wait. At this time, the branch target virtual address generated by CPU 10 via bus 908 and multiplexer 1806 is placed on bus 1807 and is sent to active list 91 to perform a matching operation. The matching process is the same as the above scenarios 3-8. The difference is that the corresponding branch target instruction is about to be executed. If BN2 obtained by matching in active list 91 cannot obtain a valid BN1X branch target in memory 902 by a matching operation (that is, a branch target instruction is not stored in L1 cache), a L2 cache block containing the branch target is filled to L1 cache immediately, and the corresponding L1 cache block address is filled into track table 13 for CPU 10 to execute. The BN1X is also stored in a table entry in memory 902 pointed to by the BN2 for using in subsequent matching operations. When cache sub-block of L2 cache is filled into L1 cache, the process is the same as the above process. A virtual page number, low bit of the tag, and a physical page number corresponding to a L2 cache sub-block are provided by a table entry of the active list 1960 pointed to by the BN2 for scanner 12 via bus 1801 and bus 1803. Other segments (e.g., index bit) are provided directly by bus 908 for scanner 12 (not shown in FIG. 18).

When an instruction read out by bus 30 of track table 13 is a direct branch type (the address format is BN2), the corresponding instruction is at least stored in L2 cache. Therefore, the BN2 is sent directly to memory 902 via bus 30 and multiplexer 901 (without active list 91). The process refers to the BN1 matching operations in the above embodiments. If BN2 obtained by matching in active list 91 cannot obtain a valid BN1X branch target in memory 902 by a matching operation (that is, a branch target instruction is not stored in L1 cache), a L2 cache block containing the branch target is filled to L1 cache immediately. The process for filling the L2 cache block is the same as the above process. A virtual page number, low bit of the tag, and a physical page number corresponding to a L2 cache sub-block are provided by a table entry of the active list 1960 pointed to by the BN2 for scanner 12 via bus 1801 and bus 1803. Other segments (e.g., index bit) are provided directly by bus 908 for scanner 12 (not shown in FIG. 18).

The instruction cache is shown in FIG. 18 and FIG. 19. The above technical solution and active list 91 can also be applied in a data cache. The main difference is that scanner 12 is replaced by data engine in the data cache. When a data cache address DBN1 is read out from track table, the address controls a L1 data cache to provide data for CPU 10, and the DBN1 is sent to the data engine. Speculative address may be obtained by adding the DBN1 to the stride (the read out entry contains the stride). When speculative load address or store address is beyond the boundary, the data engine sends the corresponding physical address or/and virtual address to active list 91 to perform a matching operation. The same operations of the embodiments in FIG. 18 and FIG. 19 are performed in the active list to generate DBN2. The generated DBN2 is sent to memory 902 to match with DBN1. Then, DBN1 or DBN2 is sent to the track table and stored in the read out entry. The similar process is not repeated herein.

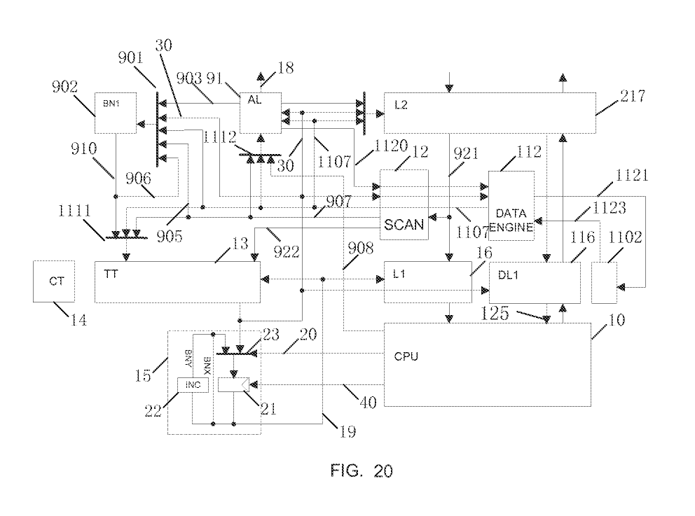

FIG. 20 illustrates a structure schematic diagram of an exemplary instruction processing system consistent with the disclosed embodiments. As shown in FIG. 20, the instruction processing system may include a CPU 10, an active list 91, a scanner 12, a correlation table 14, a tracker 15, a memory 902, a level one instruction cache 16, a level one data cache 116, and a data engine 112. It should be noted that a L2 cache 217 is a shared L2 cache for instructions and data. The shared L2 cache may store instructions or data. Accordingly, active list 91 stores block addresses corresponding to L2 cache blocks in L2 cache 217, and the table entries one-to-one correspond to L2 cache blocks in L2 cache 217, which are pointed to by the same BN2X. Because a target instruction address outputted by scanner 12 and a prediction data address outputted by data engine 112 may possibly be sent to active list 91 to perform a matching operation, a multiplexer with three-input 1112 may replace a second multiplexer 912. Because a BN outputted by scanner 12 and a DBN outputted by data engine 112 may possibly be sent to memory 902 or track table 13, a multiplexer with five-input 1105 may replace a multiplexer with four-input 901, and a multiplexer with three-input 1111 may replace a first multiplexer with two-input 911.

Active list 91 is the same as active list 91 of the described embodiments in FIG. 18 and FIG. 19. Active list 91 contains the function of TLB that can translate a virtual address into a physical address. It should be noted that, although the TLB implementation in the embodiments described in FIG. 18 and FIG. 19 is used herein, however, any one of TLB implementations described in the above embodiments may be used herein by modifying the structure, referring to the above Figures. In addition, in order to facilitate display, bus 1120 in FIG. 20 represents bus 1801 and bus 1803 in FIG. 18.

In the present embodiment, when CPU 10 executes an indirect branch instruction and data access instruction with an inaccurate prediction data address, the branch target address or the data address is sent to active list 91 to perform a matching operation via bus 908 and multiplexer 1112, and the subsequent operations are consistent with the above embodiments. However, based on BN2X sent by scanner 12 via bus 907 or DBN2X sent by data engine 112 via bus 1107, active list 91 outputs the corresponding L2 instruction block address or L2 data block address to scanner 12 or data engine 112 via bus 1120. In addition to this, all operations associated with the instruction are the same as the operations in FIG. 18 and FIG. 19, and all operations associated with the data are the same as the operations in FIG. 13, FIG. 18 or FIG. 19. Particularly, the determination logic is included in data engine 112. The determination logic may determine whether the address is beyond the page. When the prediction data address is in the same L2 data block, or the previous data block or the next data block of the L2 data block, the process is the same as the process in FIG. 13. When the prediction data address is beyond the above mentioned range, data engine 112 outputs DBN2X corresponding to the data address to active list 91 via bus 1107 to read out a corresponding virtual address/physical address. The corresponding virtual address/physical address is sent back to data engine 112 via bus 1120, and the subsequent operations are consistent with the embodiments in the FIG. 19. The process may refer to the embodiment in the FIG. 19, which is not repeated herein.

In addition, all data points of track table 13 contain DBN1. However, data points in track table 13 may contain DBN1 or DBN2 by modifying the structure in FIG. 20. For example, when the data corresponding to the predication data address is stored in L2 data cache, but the data corresponding to the predication data address is not stored in L1 data cache, the corresponding DBN2 as contents of the track point is written into the data point. When read pointer 19 of tracker 15 points to the data point, the corresponding data block read out from L2 data cache is filled to L1 data cache, and the corresponding data is sent to CPU 10 by bypass. The detailed process can refer to the above embodiments, which is not repeated herein.

There are many ways to determine whether the branch target instruction address (or the next data address) is located in a memory block containing the branch source instruction (or the current data). Basically, as shown in FIG. 12, the part corresponding to BN2Y in branch distance adds BN2Y of a branch source instruction obtain an addition result, the boundary of the part corresponding to BN2Y in the obtained addition result and other parts are called CH1. When a branch distance is positive, if all bits of outside of the part corresponding to BN2Y are ‘0’ in the branch distance, and a carry out of the addition is ‘1’ at the CH1, the branch target instruction is in the next L2 instruction block of the L2 instruction block containing the branch source.

However, if the lowest bit of the branch distance outside the part corresponding to BN2Y is ‘1’, the branch target instruction is also possible in the next L2 instruction block of the L2 instruction block containing a branch source instruction. For example, when the lowest bit of the branch distance outside the part corresponding to BN2Y is ‘1’ and all other bits are ‘0’, and there is no carry out at CH1, the branch target instruction is also in the next L2 instruction block of the L2 instruction block containing the branch source instruction. Therefore, carry output at the CH1 and the lowest bit of the branch distance outside the part corresponding to BN2Y together determine whether the branch target instruction is in the next L2 instruction block of the L2 instruction block containing the branch source instruction. The method can also be applied to a negative branch distance.

Furthermore, the method can be extended to more hierarchical cache system. A sum of the lowest bit outside a cache block offset corresponding to branch source instruction in a certain level cache (such as BN1Y, BN2Y . . . ) and the corresponding bit of the branch distance determines whether the branch target instruction is in the next or previous instruction block of the level (e.g., L2) instruction block containing the branch source instruction. Similarly, a sum of the lowest bit outside the cache block offset corresponding to the data itself in a level cache (such as DBN1Y, DBN2Y . . . ) and a stride determines whether the next data is in the next or previous data block of the level (e.g., L2) data block containing the data.

The scanner extracts instruction type from an instruction filled to a higher level cache, and calculates the branch target address of the branch instruction. That is, control flow information is extracted from programs. The extracted corresponding control flow information at least includes the instruction type. For a branch instruction, the extracted corresponding control flow information also includes the branch target instruction address. The branch target instruction address is mapped to the track address (i.e., cache address) in the active list. The control flow information is stored in the track table by the type and the track address mode. The branch point of the track table corresponds to the track address of the branch source instruction. The branch point stores the track address of the branch target instruction. Also, the location of the next instruction of the branch source instruction is implicitly included in the organization structure of the track table. Therefore, two possible forks of the subsequent instruction of a branch source instruction are constituted.

When instruction type of the track point pointed to by the read pointer of the tracker is a non-branch instruction, the read pointer moves to a next track point in order; when instruction type of the track point pointed to by the read pointer of the tracker is an unconditional branch instruction, the read pointer moves to a branch target track point; when instruction type of the track point pointed to by the read pointer of the tracker is a conditional branch instruction, based on a TAKEN signal generated by CPU, the read pointer moves to the next track point or the branch target track point. The read pointer of the tracker can start from any one of the branch points. Based on the track point type and/or the executive status of the branch point executed by the CPU, the read pointer reaches the first branch point of next sequential instruction or the first branch point of the branch target instruction and the subsequent instruction. Therefore, control flow information in the track table exists in a form of a binary tree, where each branch point corresponds to a branch instruction. The binary tree is a complete binary tree containing path information between adjacent branch points, from each branch point one can reach the subsequent branch points on its two forks.

In addition, memory 902 in FIG. 13 is similar to memory 902 in FIG. 9, where every row of memory 902 contains a corresponding relationship between a DBN1X of L1 data block and DBN2X of L2 data block. Every row of memory 902 also contains location information of the previous L2 data block or the next L2 data block of every DBN2X in active list 91. Thus, when the next data address is in the previous data block or the next data block of a L2 data block containing the current data address, the block number of the L2 data block containing the current data address is used as an addressing address to perform an addressing operation on memory 902 to read out the previous or the next data block number stored in memory 902, thereby reducing the number of matching operations in the active list.

Further, when the active list stores the location information of the previous memory block (instruction block or data block) and the next memory block of continuous address, based on the location information, the branch target instruction or the next data in the previous memory block (instruction block or data block) and the next memory block of the memory block containing the branch source instruction or the current data may be found. The same method may be repeated for several times to find the branch target instruction or the next data located in farther location, thereby reducing the number of matching operations in the active list.

For example, as shown in FIG. 9, if the scanner finds a branch target instruction is located in the sequential second instruction block of the instruction block containing the branch source instruction based on a calculation result of the adder (that is, carry output situation), the scanner outputs a BN2X corresponding to the branch source instruction to perform an addressing operation on the active list and reads out a BN2X corresponding to the next instruction block.

The scanner performs an addressing operation on the active list by the BN2X corresponding to the next instruction block and reads out a BN2X corresponding to the next instruction block of the next instruction block. That is, the scanner reads out a BN2X corresponding to the sequential second instruction block of the instruction block containing the branch source instruction. Therefore, the matching operation in the active able can be avoided by performing the addressing operation twice. When a branch target is much farther from the branch source instruction, as long as location information of the previous instruction block or next instruction block of all the instruction blocks exits and is valid, a BN2X corresponding to the branch target instruction can be found from the active list by performing the addressing operation multiple times.

For a cache with more levels or a data cache, the similar method may be used, which is not repeated herein. In addition, for a TLB module, or an active list containing virtual address-to-physical address translation, the same method can be used to find farther page (e.g., the previous page of the previous page, or the next page of the next page). The specific operations are not repeated here.

For an indirect branch instruction, a branch target instruction address is generated when the CPU executes the indirect branch instruction. Then, the branch target instruction address is sent to the active list and then is translated into a track address in the active list. Or the branch target instruction address is translated by the TLB and then is translated into a track address in the active list. Because track addresses with different formats correspond to different levels of cache, where BNX corresponds to a memory block in the corresponding level cache, and BNY corresponds to a memory cell in the memory block, so a track address is a cache address. That is, according to a track address, the corresponding instruction may be directly found in the corresponding level of cache, avoiding tag matching. However, an extra special module may be added in the system. The special module generates an indirect branch target instruction address.

For example, if an indirect branch target address is generated by a register value plus an immediate value, the special module may obtain a corresponding register value of a register file from a CPU, and the scanner sends an immediate value of the extracted indirect branch instruction to the special module. The special module may obtain an indirect branch target address by adding the register value to the immediate value. Alternatively, the special module may include a copy of the register file. When a register of the register file in the CPU is updated, the corresponding register in the copy of the register file is updated at the same time. Therefore, if the scanner sends an immediate value of the extracted indirect branch instruction to the special module, the indirect branch target address may be calculated. Thus, the branch target addresses of all the branch instructions are not generated by the CPU.

Based on the different levels where the branch target instruction or the next data are located in the cache, track addresses included in the contents of track points in the track table are different. Take the branch point as an example, when the branch target instruction is located in a L1 cache, the track address included in the branch point is BN1; when the branch target instruction is located in a L2 cache, the track address included in the branch point is BN2; when the branch target instruction is located in other level of cache, the track address follows the same pattern. The track address of the data point is similar to the track address of the branch point.

In addition, a branch target instruction or the next data is filled to at least the lowest level of cache in advance. Therefore, the track point contains only a track address (BN or DBN) that can directly address cache, but does not contain a main memory address (such as instruction address PC or data address). The address outputted by the scanner can be a track address or an instruction address, and the address outputted by data engine can also be a track address or a data address. As shown in FIG. 9, the address outputted by scanner 12 can be a BN1, a BN2, or a branch target instruction address via bus 907.

Specifically, when the branch target instruction and the branch source instruction are in the same L1 instruction block, scanner 12 directly outputs a BN1 corresponding to the branch target instruction via bus 907, and the BN1 is written to track table 13. When the branch target instruction and the branch source instruction are in different L1 instruction blocks of the same L2 instruction block, scanner 12 outputs a BN2 via bus 907. The BN2 is translated into a BN1 corresponding to the branch target instruction in memory 902, and the BN1 is written to track table 13. When the branch target instruction are in the previous L2 instruction block or the next L2 instruction block of the same L2 instruction block containing the branch source instruction, scanner 12 outputs a BN2 via bus 907. A BN2X of the previous L2 instruction block or the next L2 instruction block may be read out by using the BN2 in active list 91. Then, a BN1 corresponding to the branch target instruction may be obtained and written to track table 13 using the above method. In other situations, scanner 12 outputs an obtained branch target instruction address by calculation to active list 91 to perform a matching operation via bus 907. Then, a BN1 corresponding to the branch target instruction may be obtained and written to track table 13 using the above method.

Therefore, after scanner 12 determines the location of the branch target instruction, scanner 12 can generate an address type number. The address type number is used to represent address type of the address on bus 907, therefore controlling the corresponding module to perform subsequent operations. For example, the above four situations can be represented using a 2-digit address type number. When bus 907 outputs the track address or the branch target address, bus 907 also outputs the address type number to track table 13, active list 91, memory 902 and other related modules. Thus, different types of addresses can be transmitted via the same bus 907, reducing a total number of buses.

The address type number with more bits can represent more situations. For example, as shown in FIG. 17, except for BN1 and BN2 (containing the same L2 instruction block and the previous L2 instruction block or the next L2 instruction block), the address format on bus 1506 can also be a virtual address or a physical address. Therefore, there are 6 situations in total. The address type number with 3 bits can represent the 6 situations. The address type number with more bits can be applied to more levels of cache (that is, there are more track addresses), addresses outputted by a data engine, and so on. The descriptions are not repeated herein.

In addition, when a branch target instruction address or the address of the next data is in the same page containing the branch source instruction address or the address of the current data, a more flexible method can be used to implement a TLB translation. As shown in FIG. 15, active list 91 outputs the physical address and the virtual address of the branch source instruction to scanner 12 via bus 1505 and bus 1504, respectively. Then, scanner 12 can calculate the physical address and the virtual address of the branch target instruction by using the outputted physical address and virtual address of the branch source instruction.

When scanner 12 calculates the physical address of the branch target instruction, if scanner 12 finds that the branch target instruction address and the branch source address are in the same page, scanner 12 outputs the physical address of the branch target instruction via bus 1506. The physical address of the branch target instruction via multiplexer 1508 and bus 1509 is sent to active list 91 to match with the physical address stored in active list 91, and the subsequent operations are consistent with the above embodiments.

If scanner 12 finds that the branch target instruction address is in the previous or next page of the page containing the branch source address, scanner 12 outputs the physical address page number of the physical address of the branch target instruction sent from active list 91 via bus 1512. After the physical address page number is selected, the selected page number is sent to TLB 1301 to match with the physical address page number stored in TLB 1301.

If the match is successful, the row number including previous or next page of the successfully matched page number stored in memory block 1510 or memory block 1511 is as an addressing address, and the row containing the previous or next page is found by addressing on TLB 1301. The physical address page number is read out from the row and sent out via bus 1507. After the physical address page number is selected by multiplexer 1508, the selected physical address page number and the low bit of the tag outputted by scanner 12 via bus 1506 are merged. The merged result constitutes a physical address. The physical address is sent to active list 91 via bus 1509 to match with the physical address stored in active list 91, and the subsequent operations are consistent with the above embodiments. If the match is unsuccessful, the subsequent operations (e.g., filling operation) are consistent with the above embodiments.

If scanner 12 finds that the branch target instruction address is not in the page containing the branch source address and not in the previous or next page of the page containing the branch source address, scanner 12 outputs a virtual page number of the obtained virtual address of the branch target instruction by calculation via bus 1512 to TLB 1301. The selected virtual page number of the obtained virtual address of the branch target instruction matches with the virtual page number stored in TLB 1301, and the subsequent operations are consistent with the above embodiments.

As shown in FIG. 19, segment 1910 of an anti-aliasing table 1950 stores a virtual page number. The virtual page number and the physical address page number of the row of active list pointed to by BN2X in segment 1912 together constitute a pair of virtual and physical addresses (The virtual page number and physical address page number of the row of the active list together also constitute a pair of virtual and physical addresses, so multiple virtual pages correspond to a physical address page), thus active list 91 containing anti-aliasing table 1950 can achieve the role of TLB. Further, segment 1910 also can store a low bit of the corresponding tag (corresponding to a low bit of the corresponding tag in segment 1904) to constitute a virtual address of a L2 memory block. Once the match is successful in anti-aliasing table 1950, the corresponding L2 instruction block can be directly found, omitting some operations shown in FIG. 19, such as reading out physical address page number, constituting physical address of L2 instruction block and then matching.

As shown in FIG. 20, L2 cache 21 can be shared by instructions and data, and each has a separate L1 cache (L1 instruction cache 116 and L1 data cache 16). At this time, active list 91 stores block addresses of instruction cache blocks or data cache blocks included in various memory blocks in L2 cache. In the L2 cache 217, both instructions and data use track addresses with BN2 format. Because memory 902 stores a corresponding relationship that a BN2 is translated into a L1 cache track address (BN1 or DBN1), the address included in the track point of track table 13 can be BN1, DBN1, or BN2. The BN2 can be translated into BN1 or DBN1 by the previous methods. For more levels of cache, no matter how many levels of low-level cache is a shared cache for instructions and data, the same method can be used to determine the track address, and a low-level cache track address may be translated into a corresponding high-level cache track address.

The disclosed systems and methods may provide fundamental solutions to cache structures used by digital systems. Different from traditional cache systems, which fills the cache after cache miss, the disclosed systems and methods fill the instruction cache before the execution of an instruction in the memory, thus avoiding or sufficiently hiding the compulsory miss. Further, the disclosed systems and methods provide essentially a fully associative cache structure to avoid or hide the conflict miss and capacity miss. In addition, the disclosed systems and methods prevent the delay of the critical path of the cache read by tag matching and, thus, can run at a higher clock frequency. Thus, the matching operations and miss rate can be reduced, and the power consumption can be significantly lowered. Other advantages and applications of the present invention will be apparent to professionals in the art.

The disclosed systems and methods may also be used in various processor-related applications, such as general processors, special-purpose processors, system-on-chip (SOC) applications, application specific IC (ASIC) applications, and other computing systems. For example, the disclosed devices and methods may be used in high performance processors to improve overall system efficiency.

The embodiments disclosed herein are exemplary only and not limiting the scope of this disclosure. Without departing from the spirit and scope of this invention, other modifications, equivalents, or improvements to the disclosed embodiments are obvious to those skilled in the art and are intended to be encompassed within the scope of the present disclosure.

1. An instruction processing system, comprising:
m number of memory devices with different access speeds configured to store executable instructions, wherein m is a natural number greater than or equal to two and the m number of memory devices include at least a memory with a lower speed and a memory with a higher speed;
a central processing unit (CPU) capable of being coupled to the m number of memory devices, and configured to execute one or more instructions of executable instructions; and
an instruction control unit configured to, based on a track address of a target instruction of a branch instruction stored in a track table, control the memory with a lower speed to provide the instructions for the memory with a higher speed.

2. The system according to claim 1, wherein:
the instruction control unit includes the track table containing a plurality of track table rows, each table row corresponding to a track, each track corresponds to a memory block in the memory with a highest speed;
a table row includes a plurality of entries, each entry being a track point corresponding to an instruction stored in a memory with a highest speed, wherein a target instruction of a branch instruction is stored in one or more of the m number of memory devices, and the track point includes of the branch instruction a track address of the target instruction;
based on different levels of memory which any one of the branch target instruction and data locates at, different types of the track addresses are stored in the track point of the track table;
the different types of track addresses correspond to different levels of memory; and
the track table implements a complete program control flow based on the target instruction, a next sequential instruction, and an end track point indicating a next instruction block.

3. (canceled)

4. The system according to claim 1, further including:
an active list configured to store block addresses of instructions stored in a memory with a lowest access speed, and track addresses of other m−1 number of memory devices when instructions stored in the memory with the lowest access speed is stored in other m−1 number of memory devices,
wherein, based on the active list, one format of track address corresponding to one level of memory is able to be mapped to another format of track address corresponding to another level of memory;
when a match result indicates that the target instruction of the branch instruction is not stored in the memory with the higher speed, the active list controls the memory with the lower speed to provide the target instruction of the branch instruction.

5. The system according to claim 4, wherein:
the track address of the target instruction of the branch instruction includes a row number and a column number;
after the block address of the target instruction of the branch instruction is performed a matching operation via the active list, the row number of the track address is obtained; and
an offset of the target instruction of the branch instruction in the instruction block is the column number of the track address.

6. The system according to claim 5, wherein:
the instruction control unit further includes a tracker, wherein:
based on tracks stored in the track table, the tracker moves and points to a track point in the track table corresponding to a first layer branch instruction, and reads out the track address of the target instruction of the branch instruction from the track table;
the instruction control unit finds that the track address of the target instruction corresponds to the memory with the highest speed, the memory with the highest speed provides the instruction for the CPU; and
the instruction control unit finds that the track address of the target instruction corresponds to at least one memory of the m−1 number of memory devices except the memory with the highest speed, the at least one memory of m−1 number of memory devices provides the instruction for the CPU and the memory with the highest speed in advance.

7. The system according to claim 6, wherein the tracker includes:
a register configured to store the track address, which addresses the track table and the memory of the highest access speed, corresponding to the first layer of branch instruction, wherein the track address is used to read out the track address corresponding to the target instruction by performing an addressing operation in the track table;
an incrementer configured to obtain the track address of a next branch instruction of the first layer of branch instruction segment; and
a selector configured to select one of the track address of the target instruction of the first layer of branch instruction from the track table and the track address of a next sequential instruction from the incrementor, and to store the selected track address in the register, wherein the selector is controlled by a branch decision generated by the CPU.

8. The system according to claim 6, wherein:
the instruction control unit further includes a predictor, the predictor being configured to:
obtain an n-th layer of branch instruction segment after the first layer of branch instruction segment, n being a natural number greater than or equal to two; and
control the memory with the lower speed to provide the n-th layer of branch instruction segment that is not stored in the memory with the higher speed for the memory with the higher speed.

9. (canceled)

10. The system according to claim 8, wherein the predictor includes:
an incrementer configured to obtain the track address of the branch instruction of the n-th layer of branch instruction segment;
2ⁿ registers configured to store the track addresses of the branch instructions of the n-th layer of branch instruction segment, respectively; and
a selector configured to select the track address of the branch instruction by performing an addressing operation in the track table to obtain the track address of the target instruction of the branch instruction.

11. (canceled)

12. The system according to claim 5, wherein the instruction control unit further includes:
a prediction tracker configured to obtain an n-th layer of branch instruction segment after the first layer of branch instruction segment, and to control the memory with the lower speed to provide the n-th layer of branch instruction segment to the memory with the higher speed, wherein n is a natural number greater than one.

13. The system according to claim 12, wherein the prediction tracker includes:
an incrementer configured to obtain the track address of the branch instruction of the n-th layer of branch instruction segment;
2ⁿ⁺¹-2 registers configured to store the track addresses of the branch instructions of the first to the n-th layer of branch instruction segments, respectively; and
n+1 layers of selectors configured to, based on information on whether the branch of the branch instruction is taken, prune the track addresses corresponding to the branch instruction segments that are not executed in sequence.

14. The system according to claim 13, wherein:
after pruning the track address, the outputted track address points to the first layer of the branch instruction;
based on the track address, the track address of the target instruction of the first layer of the branch instruction is read out from the track table; and
based on the track address of the target instruction, the instruction from the memory with the highest speed is provided for the CPU.

15. (canceled)

16. The system according to claim 4, further including:
a scanner configured to detect branch instructions amongst instructions moved between different level of memories, to calculate addresses of target instructions of branch instructions and to send block addresses of target instructions to the active list to perform matching operations to obtain the corresponding track addresses of other memory level of the target instructions, wherein the track address of the target instruction is stored in a track table entry corresponding to the branch instruction.

17-34. (canceled)

35. The system according to claim 14, wherein:
the scanner determines whether the branch target instruction address is beyond a boundary; and
based on a determination result, the branch target instruction located on the different locations is given to different format addresses.

36. The system according to claim 14, wherein:
the instruction processing system also includes a data engine configured to determine whether a next data address of a data access instruction is beyond the boundary; and
based on a determination result, the next data located on the different locations is given to different format addresses.

37. (canceled)

38. (canceled)

39. (canceled)

40. (canceled)

41. (canceled)

42. (canceled)

43. (canceled)

44. (canceled)

45. The system according to claim 2, wherein:
every level of data memory also corresponds to a data track address translation module; rows of the data track address translation module and data blocks in the level of data memory have a one-to-one correspondence, wherein:
each row stores a data block number and a corresponding sub-block number in the lower level of data memory containing the data block in the level of data memory, thus the block number of data track address of the level of data memory is translated to the data block number of data track address of the lower level of data memory; and
the sub-block number and a block offset of data track address of the level of data memory are merged to form the data block offset of data track address of the lower level of data memory.

46. The system according to claim 2, wherein:
instructions and data share a memory with the lower access speed; and
block addresses of instruction blocks and data blocks of a memory with the lowest access speed are stored in the active list.

47-85. (canceled)

86. The system according to claim 6, wherein:
when an instruction type read out from a track point in the track table is of a type of indirect branch, the CPU executes a corresponding instruction and generate a branch target address, and the active list translates the target address into a track address and stores the track address into the track point;
when the read pointer of the tracker points to the track point again, the address is used as a direct branch point to perform a speculative execution, and the branch target address generated currently by the CPU are compared with the instruction address corresponding to the track address of the track point, wherein:
when the branch target address generated currently by the CPU is equal to the instruction address corresponding to the track address of the track point, speculative execution is correct and the subsequent operation is executed; and
when the branch target address generated currently by the CPU is not equal to the instruction address corresponding to the track address of the track point, speculative execution is incorrect, and the branch target address generated by the CPU is translated into the track address, then the subsequent operation is executed.

87. The system according to claim 16, further including:
a virtual to physical translation unit situated between the CPU and the active list, each of entry of the virtual to physical translation unit also stores a physical page address of a virtual previous page or next page,
wherein:
the scanner or a data engine computes a branch target instruction address or a next data address based on a current physical data address;
when the branch target instruction address or the next data address does not exceed a current page boundary, the branch target instruction address or the next data address is directly sent to the active list to be translated into a track address; and
when the branch target instruction address or the next data address exceeds the current page boundary, the CPU generated addresses is sent to the virtual to physical address translation unit and translated into a physical address, the physical address is sent to the active list to be translated into a track address;
after any one of an indirect branch target instruction address and a data address generated by the CPU is translated into a physical address by the virtual-to-physical translation module, the physical address is sent to the active list and translated into a track address.

88. The system according to claim 87, wherein:
track addresses of a previous memory block and a next memory block of one memory block are stored in the active list
when any one of an instruction address and a data address is stored in any one of a previous memory block and a next memory block of a current memory block in the memory corresponding to the active list, based on memory location information of any one of the previous memory block and the next memory block stored in the active list, any one of the instruction and data is found directly;
when any one of an instruction address and a data address is stored in any one of a previous memory page and a next memory page of a current memory page in the memory corresponding to the virtual to physical address translation unit, based on memory location information of any one of the previous memory page and the next memory page stored in the virtual to physical address translation unit, any one of the instruction and data is found directly.

89. An instruction processing method, comprising:
providing m number of memory devices with different access speeds configured to store executable instructions, wherein m is a natural number greater than one and the m number of memory devices include at least a memory with a lower speed and a memory with a higher speed;
providing a track table containing a plurality of track table rows, each table row corresponding to a track;
calculating an address of a target instruction of a branch instruction of instructions of an instruction block;
after performing a matching operation on the address of the target instruction of the branch instruction, obtaining a row number of the track address corresponding to the target instruction;
obtaining a column number of the track address corresponding to the target instruction by an offset of the target instruction in the instruction block; and
based on the row number and the column number of the track address corresponding to the target instruction of the branch instruction stored in the track table, controlling a memory with a lower speed to provide the instructions for a memory with a higher speed.

90. The method according to claim 89, wherein:
a track table row includes a plurality of entries, each entry corresponding to a track point, which stores a track address of a target instruction of a branch instruction stored in a memory with a highest speed, wherein the target instruction of the branch instruction is stored in at least one memory of the m number of memory devices with different access speeds;
control flow information in the track table exists in a form of a binary tree, wherein each branch point corresponds to a branch instruction;
the binary tree contains path information between two adjacent branch points, therefore every adjacent subsequent branch point of two forks can be reached from a branch point;
the track address in the track point of the track table is stored in a different format based on different level memory which any one of branch target instruction and data is located in; and
each different format of track address corresponds to a different level memory.

91. The method according to claim 89, wherein controlling a memory with a lower speed to provide the instruction for a memory with a highest speed includes:
based on the track address of the target instruction of the branch instruction stored in the track table, moving and pointing to a first layer of the branch instruction in advance of execution of the branch instruction by a central processing unit (CPU);
reading out the track address of the target instruction of the first layer of the branch instruction from the track table;
when the track address of the target instruction corresponds to the memory with the highest speed, providing, by the memory with the highest speed, the instruction for the CPU; and
when the track address of the target instruction corresponds to the m−1 number of memory devices except the memory with the highest speed, providing, by the m−1 number of memory devices, the instruction for the CPU and the memory with the highest speed in advance.

92. The method according to claim 90, wherein:
when the track address read out from the track point of the track table is the track address corresponding to the memory with the lower access speed, the track address is translated into the track address corresponding to the memory with the higher access speed;
the track address is filled to the track point of the track table; and
one of instruction block or data block corresponding to the track address is stored in the memory with the higher access speed from the memory with the lower access speed at the same time.

93. The method according to claim 89, further including:
determining whether the branch target instruction address is beyond the boundary; and
based on a determination result, giving the branch target instruction located on the different locations to different format addresses.

94. The method according to claim 93, further including:
recording memory block information in the lower level memory corresponding to every data block in a higher level memory; and
based on the information, translating the data track address corresponding to the higher level memory to the data track address corresponding to the lower level memory.

95. The method according to claim 89, wherein:
instructions and data share a memory with the lower access speed; and
block addresses of instruction blocks and data blocks of a memory with the lowest access speed are stored in an active list.
